(19) United States
(12) Patent Application Publication
(10) Pub. No.: US 2018/0275846 A1
(43) Pub. Date: Sep. 27, 2018

(54) CONTEXT-SENSITIVE OVERLAYS FOR A CALENDAR APPLICATION

(71) Applicant: salesforce.com, inc., San Francisco, CA (US)

(72) Inventors: Eric Alexander Hurlimann Perret, San Francisco, CA (US); Anthony Desportes, San Francisco, CA (US); Kapildev Reddy Gowru, San Francisco, CA (US); Tigran Abovyan, North Bergen, NJ (US); Ravi L. Honakere, San Ramon, CA (US); Kayvaan Ghassemieh, San Francisco, CA (US); Vatsal Shah, Hayward, CA (US)

(73) Assignee: salesforce.com, inc., San Francisco, CA (US)

(21) Appl. No.: 15/470,485

(22) Filed: Mar. 27, 2017

(51) Int. Cl. G06F 3/0484; G06Q 10/10; G06F 3/0482; G06F 17/30

(52) U.S. Cl. CPC G06F 3/0484; G06F 17/30424; G06F 3/0482; G06Q 10/1093

(57) ABSTRACT

Methods and systems are provided for displaying a context-sensitive overlay in conjunction with a calendar displayed by a calendar application. The calendar application can determine contextual information from the calendar that indicates context for the calendar. The contextual information comprises calendar data or third-party data linked to calendar items that are displayed in the calendar. The calendar application can automatically query a backend system to dynamically determine, based on the contextual information, at least one context-sensitive overlay that is pertinent to the calendar in view of the contextual information. The context-sensitive overlay provides supplemental information that is directly associated with the contextual information from the calendar. The context-sensitive overlay can be displayed in conjunction with the calendar so that it is superimposed on at least a portion of the calendar.

### TECHNICAL FIELD

Embodiments of the subject matter described herein relate generally to cloud-based computing. More particularly, embodiments of the subject matter relate to methods and systems for providing context-sensitive overlays for a calendar application.

### BACKGROUND

Today many enterprises now use cloud-based computing platforms that allow services and data to be accessed over the Internet (or via other networks). Infrastructure providers of these cloud-based computing platforms offer network-based processing systems that often support multiple enterprises (or tenants) using common computer hardware and data storage. This “cloud” computing model allows applications to be provided over a platform “as a service” supplied by the infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without compromising data security. Generally speaking, multi-tenancy refers to a system where a single hardware and software platform simultaneously supports multiple organizations or tenants from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application feature software between multiple sets of users.

A cloud-based computing environment can include a number of different data centers, and each data center can include a number of instances, where each instance can support many tenants (e.g., 10,000 tenants or more). As such, large numbers of tenants can be grouped together into and share an instance as tenants of that instance. Each tenant is its own organization (or org) that is identified by a unique identifier (ID) that represents that tenant's data within an instance.

A calendar application is software that provides users with an electronic version of a calendar that displays dates and times, and a host of other features including appointment calendaring, scheduling and reminders, availability sharing, integrated email, calendar publishing, an address book and/or contact list (e.g., a list of contacts with information to enable users to communicate with the contacts), time management software, etc. Various calendar applications are in use today, including iCal™, Google™ Calendar, and Microsoft™ Office 365, Microsoft™ Outlook with Exchange Server to name a few. These applications present an interface that allows a user to create an event at a specified time. The user may track various events, including meetings that the user has been invited to. Most calendar applications also allow a user to send invite requests for events to other users. When an invitee receives the request, the invitee can choose to accept or decline the request. If the invitee accepts, a corresponding event is typically created in the invitee's calendar.

Many professionals (e.g., sales and marketing professionals, engineers, attorneys, etc.) typically manage their day using an electronic calendar. However, presently known calendaring applications do not include contextual information that may be available from various sources, such as external databases. As a result, a person's calendar may include meetings with individuals and companies, but may lack contextual information about those entities.

Some calendar systems allow users to create a combined view of their calendars by layering more calendars on top of a master calendar. For example, a user can have a main calendar that he/she is currently looking at in their account, and they can add any other calendar such that it is “overlaid” onto the main calendar. In some cases the different calendars are color coded so that the user can differentiate between them. As such, a user can combine separate calendars that have different calendar events so that the user can see all of all of their calendar events at once. In addition, some calendaring systems have a predefined set of overlays that are displayed in conjunction with a calendar, such as current weather, working hours, etc.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an example of a multi-tenant computing environment in which features of the disclosed embodiments can be implemented in accordance with the disclosed embodiments.

FIG. 2 is a block diagram of a cloud-based computing platform in accordance with the disclosed embodiments.

FIG. 3 is a flow chart that illustrates an exemplary method for generating and displaying an overlay in conjunction with a calendar displayed by a calendar application in accordance with the disclosed embodiments.

FIG. 4 is a flow chart that illustrates an exemplary method for providing context-sensitive overlays for a calendar application in accordance with the disclosed embodiments.

FIG. 5 illustrates a screenshot that shows an example of a calendar creation page for creating calendar in a calendaring application in accordance with the disclosed embodiments.

FIG. 6 illustrates a screenshot that shows an example of a calendar selection tab for selecting different calendars in a calendar application in accordance with the disclosed embodiments.

FIG. 7 is a flow chart that illustrates an exemplary method for automatically querying backend systems to generate a list of overlays that are pertinent to the calendar based on calendar data or third-party data in accordance with the disclosed embodiments.

FIGS. 8A and 8B collectively illustrate a flow chart of an exemplary method for identifying a set of the stored associative rules and generating new associative rules that are applicable to a calendar in accordance with the disclosed embodiments.

FIG. 9 illustrates a screenshot that shows one example of an overlay management screen that can be used to manage which overlays are displayed on a calendar of a calendaring application in accordance with the disclosed embodiments.

FIG. 10 illustrates a screenshot that shows one example of an overlay displayed on a portion of a calendar of a calendaring application in accordance with the disclosed embodiments.

FIG. 11 illustrates a screenshot that shows one example of an overlay displayed on a portion of a calendar of a calendaring application in accordance with the disclosed embodiments.

FIG. 12 illustrates a screenshot that shows other examples of overlays that can be displayed on a portion of a calendar of a calendaring application in accordance with the disclosed embodiments.

FIG. 13 shows a block diagram of an example of an environment in which an on-demand database service can be used in accordance with some implementations.

FIG. 14 shows a block diagram of example implementations of elements of FIG. 13 and example interconnections between these elements according to some implementations.

FIG. 15A shows a system diagram illustrating example architectural components of an on-demand database service environment according to some implementations.

FIG. 15B shows a system diagram further illustrating example architectural components of an on-demand database service environment according to some implementations.

FIG. 16 illustrates a diagrammatic representation of a machine in the exemplary form of a computer system within which a set of instructions, for causing the machine to perform any one or more of the methodologies discussed herein, may be executed.

### DETAILED DESCRIPTION

One drawback of these existing calendar overlays is that they are not tailored to the specific calendar being displayed. In addition, the information presented via the overlay does not supplement other calendar information or data that is part of the calendar. Another drawback of calendaring systems that have such overlays is that each overlay is associated with a calendar of the user's account and a visible date range. As such, when a user shares his/her calendar with another user, any overlays are not shared with the other user, and although the other users can see the items on that user's calendar, they can not see overlays that could be useful to the other users.

It would be desirable to provide calendaring systems and applications for providing context-sensitive informational overlays that can be displayed in conjunction with a calendar. In accordance with the disclosed embodiments, context-sensitive overlays are provided that can be displayed in conjunction with a calendar. The overlays are “context-sensitive” in that they dynamically generated based on content of contextual information from the calendar. This contextual information can be, for example, calendar data (e.g., data displayed on the calendar, data defined on the calendar or defined on items that are displayed in or on the calendar), and/or or data linked to calendar data (e.g., third-party data linked to the items that are displayed in or on the calendar). As a non-limiting example, in some embodiments, overlays can be generated based on the events linked to a calendar and the data that defines the calendar, where context sensitive metadata is the data backing the overlays for a calendar and its events. As used herein, “context sensitive metadata” can refer to “first” data that provides information about other “second” as it directly relates to the other “second” data. As the set of circumstances or facts that are associated with the first data changes, the first data also changes. As such, each context-sensitive informational overlay is directly associated with content of the calendar data. Stated another way, each overlay is pertinent to the calendar in view of the contextual information that appears in the calendar. Each overlay can be displayed in accordance with a time or time-range and/or date or date-range within the calendar, and provides supplemental information that is related to the contextual information from the calendar.

In some of the disclosed embodiments, systems and methods are provided for displaying an overlay in conjunction with a calendar displayed by a calendar application. The calendar application can determine contextual information displayed on the calendar. This contextual information indicates context for the calendar, and can include calendar data and/or third-party data linked to calendar items that are displayed in the calendar. The calendar data can be, for example, data defined on the calendar, or data defined on items that are displayed in the calendar. The items can include one or more of calendar events and calendarable records being displayed on the calendar. Based on the contextual information, the calendar application can automatically query a backend system to dynamically determine, based on the contextual information, at least one context-sensitive overlay that is pertinent to the calendar in view of the contextual information. The user can then be presented with an option to display the overlay(s) with the calendar in conjunction with the calendar. When superimposed on the calendar the context-sensitive overlay(s) provide supplemental information that is related to the contextual information and enhances the calendar.

In one embodiment, the calendar application can generate a list of those overlays for the user. For example, the calendar application can determine whether any existing overlays are stored for this calendar, and add any existing overlays to the list of pertinent overlays. In addition, the calendar application can also determine, based on associative rules and data regarding frequency of use in other calendars by other users, other overlays that are applicable for this calendar, and also add these other overlays to the list of pertinent overlays.

To do so, in one embodiment, The system and method for displaying a context-sensitive overlay in conjunction with a calendar that is displayed by a calendar application determining contextual information from the calendar that indicates context for the calendar. The contextual information can include calendar data or third-party data linked to calendar items that are displayed in the calendar. One or more backend systems can be automatically queried to dynamically determine, based on the contextual information, at least one context-sensitive overlay that is pertinent to the calendar. The context-sensitive overlay is pertinent in view of the contextual information and provides supplemental information that is directly associated with the contextual information from the calendar. The context-sensitive overlay can be displayed with the calendar such that the overlay superimposed on at least a portion of the calendar. In some embodiments, a list of pertinent context-sensitive overlays, that are determined to be pertinent to the calendar and available to be displayed in conjunction with the calendar, can be generated and displayed at a user interface with options for selecting one or more of the context-sensitive overlays to be displayed.

In one embodiment, stored associative rules can be analyzed to determine whether any of the contextual information matches a pattern defined by associative data for that associative rule. This allows for a set of stored associative rules to be identified that are applicable to the calendar. The set of stored associative rules includes each of the stored associative rules that were determined to have a pattern that matches the contextual information. Each of the stored associate rules has a corresponding context-sensitive overlay. Based on the set of stored associative rules that are determined to be applicable to the calendar, a set of stored context-sensitive overlays can be generated that are or could be applicable to the calendar.

An association rule-learning algorithm can also be used to process the contextual information to extract patterns from the contextual information, and based on each new pattern that gets extracted, a new associative rule can be generated. Each new associative rule can include associative data that reflects that new pattern, and corresponds or is linked to a new context-sensitive overlay so that a new context-sensitive overlay (applicable for the calendar) can be generated based on that new associative rule. The set of stored context-sensitive overlays and the new context-sensitive overlays can then be added to the list of pertinent context-sensitive overlays such that when a user selects one or more of the pertinent context-sensitive overlays from the list, the selected, pertinent context-sensitive overlays will be displayed on the calendar (e.g., superimposed on at least a portion of the calendar).

Time-based data and/or the date-based data defines location of the new context-sensitive overlays on the calendar. The new overlays can then be added to the list of pertinent overlays that is displayed to the user. The user can select one or more of the pertinent overlays to be displayed, and the selected overlays can then be saved and displayed on the calendar (e.g., superimposed on the calendar or an event within the calendar). The calendar application persists the association between the selected, pertinent overlay(s) and the calendar such that the selected, pertinent overlay(s) will be displayed when the calendar is displayed, will be hidden when the calendar is hidden, and will be shared when the calendar is shared with other users.

In one embodiment, overlays displayed on a calendar are generated based on the events linked to a calendar and the data that defines the calendar, where the context sensitive metadata is the data backing the overlays. It provides the metadata (or supplemental information) for a calendar and its events.

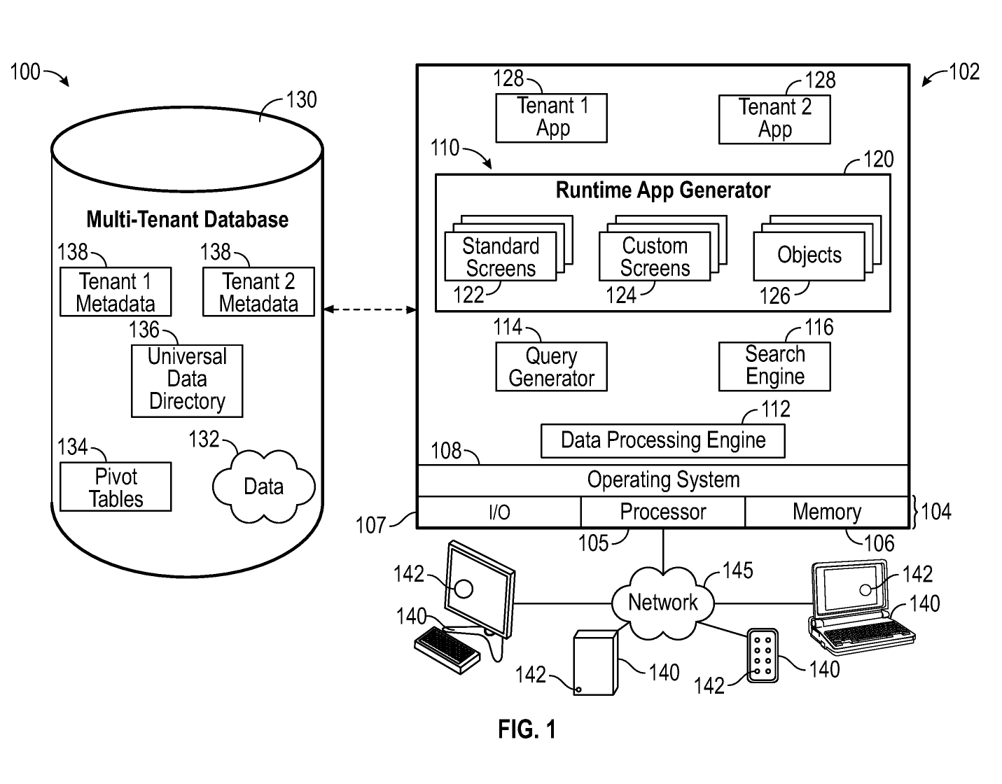

FIG. 1 is a schematic block diagram of an example of a multi-tenant computing environment in which features of the disclosed embodiments can be implemented in accordance with the disclosed embodiments. As shown in FIG. 1, an exemplary cloud based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of user systems 140, such as desktops, laptops, tablets, smartphones or other client devices, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the system 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the user systems 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the user systems 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user systems 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its user system 140, as appropriate.

The runtime application generator 120 suitably interacts with the query generator 114 to efficiently obtain multi-tenant data 132 from the database 130 as needed in response to input queries initiated or otherwise provided by users of the user systems 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled user system 140 on the network 145. In an exemplary embodiment, the user system 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the user system 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the user system 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of a collaboration solution such as the Chatter system, described below.

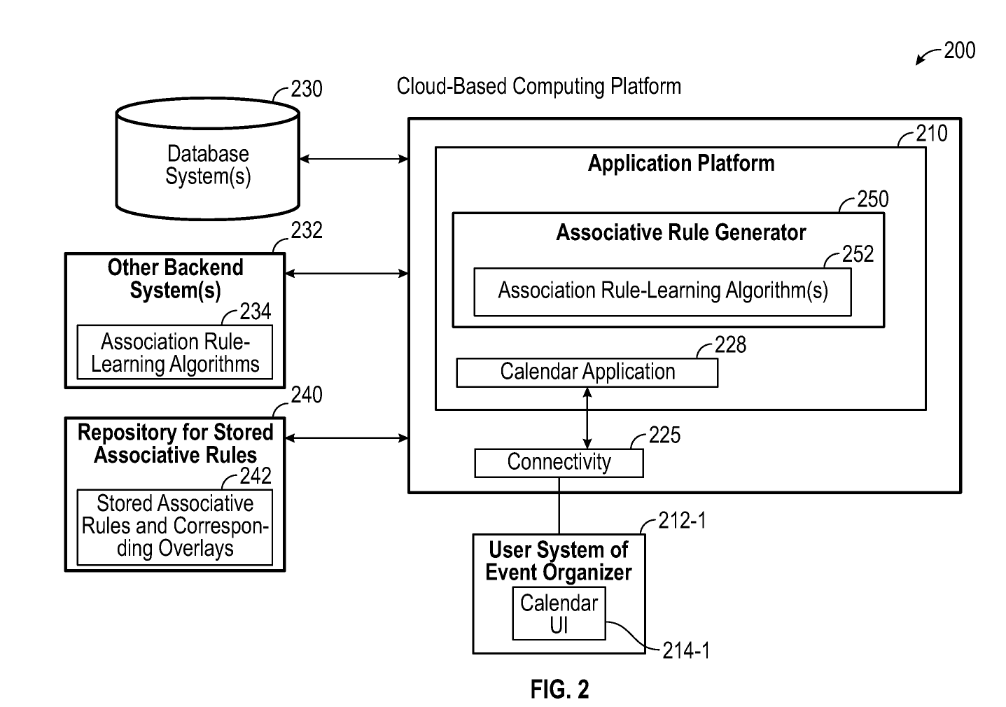

FIG. 2 is a block diagram of a cloud-based computing platform 200 in accordance with the disclosed embodiments. The cloud-based computing platform 200 is a system that can be shared by many different organizations, and handles the storage of, and access to, different metadata, objects, data and applications across disparate organizations. In one embodiment, the cloud-based computing platform 200 can be part of a database system, such as a multi-tenant database system. The cloud-based computing platform 200 is configured to handle requests for any user associated with any organization that is a tenant of the system. Although not illustrated, the cloud-based computing platform 200 can include other components such as one or more processing systems that execute applications, process space where the applications run, and program code that will be described in greater detail below.

The cloud-based computing platform 200 includes a connectivity engine 225 serves as a network interface that allows a user of a user system 212 to establish a communicative connection to the cloud-based computing platform 200 over a network (not illustrated in FIG. 2) such as the Internet or any type of network described herein.

The cloud-based computing platform 200 includes an application platform 210 and one or more user systems 212 that can access various applications provided by the application platform 210. The application platform 210 is a cloud-based user interface.

The cloud computing platform 200 (including the application platform 210 and database systems 230) are part of one backend system. The application platform 210 also has access to one or more other backend systems 240. Other backend systems 232 can include, for example, an on-premises exchange server, the system/servers used by Google to allow users to perform searches, the system/server used to retrieve Wikipedia articles based on user input, etc. Although not illustrated, each backend system can include one or more servers that work in conjunction with one or more databases and/or data processing components.

The application platform 210 has access to one or more database systems 230 that store information (e.g., data and metadata) for a number of different organizations including user information, organization information, custom information, etc. The database systems 230 can include a multi-tenant database system 130 as described with reference to FIG. 1, as well as other databases or sources of information that are external to the multi-tenant database system 130 of FIG. 1. In one embodiment, the multi-tenant database system 130 can store data in the form of records and customizations. As used herein, the term “record” refers to an instance of a data object created by a user of a database service, for example, about a particular (actual or potential) business relationship or project. The data object can have a data structure defined by the database service (a standard object) or defined by a subscriber (custom object). For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is trying working on. In one embodiment implementing a multi-tenant database, all of the records for the tenants have an identifier stored in a common table. A record has data fields that are defined by the structure of the object (e.g. fields of certain data types and purposes). A record can also have custom fields defined by a user. A field can be another record or include links thereto, thereby providing a parent-child relationship between the records. Customizations can include custom database objects and fields, Apex Code, Visualforce, Workflow, etc.

The computing platform 200 can provide applications and services and store data for any number of organizations. Each organization is a source of metadata and data associated with that metadata that collectively make up an application. In one implementation, the metadata can include customized content of the organization (e.g., customizations done to an instance that define business logic and processes for an organization). Some non-limiting examples of metadata can include, for example, customized content that describes a build and functionality of objects (or tables), tabs, fields (or columns), permissions, classes, pages (e.g., Apex pages), triggers, controllers, sites, communities, workflow rules, automation rules and processes, etc. Data is associated with metadata to create an application. Data can be stored as one or more objects, where each object holds particular records for an organization. As such, data can include records (or user content) that are held by one or more objects. For example, an “calendar” object can hold calendar records of an organization.

Based on a user's interaction with a user system 212, the application platform 210 accesses an organization's data (e.g., records held by an object) and metadata that is stored at one or more database systems 230, and provides the user system 212 with access to applications based on that data and metadata. These applications can include a calendar application 228 that will be described in greater detail below. The various user systems 212 can interact with a calendar application 228 provided by the cloud-based computing platform 200.

The calendar application 228 is executable to maintain one or more calendars that can be presented via a graphical interface 214 to a user of one of the user systems 212. The calendar application 228 may allow the user to create and maintain multiple calendars. Each calendar can be defined, for example, as a chart or series of pages showing the days, weeks, and months of a particular year, or giving particular seasonal information. This is also sometimes referred to as the calendar definition. The calendar definition can also hold data which occurs at a point in time relative to the timeframe being included and/or data which occurs over a period of time with a start and an end, relative to the timeframe being included.

The calendar application 228 may allow the user to create calendar events on particular days at particular times, and allow a user to invite others to created calendar events as well as receive invitations from others to calendar events. The calendar application 228 may send an invitation to the other user, which can be accepted or declined. The calendar application 228 may also allow a user to set reminders for calendar events that trigger notifications (e.g., a reminder for a notification a certain amount of time before an event is scheduled to begin). The calendar application 228 may maintain a calendar by storing various forms of event information in one or more database systems 230. Event information may include, without limitation, an event name, the start and end times for the event, the invitees of the event, etc. In various embodiments, event information may be accessible to other processes.

Some calendar applications are local and designed for individual use, whereas others are networked applications that allow for the sharing of information between users. In addition, some calendar applications are cloud-based to further extend users ability to share calendar information with other users. In this embodiment, the calendar application 228 is hosted via the cloud-based computing platform 200 to allow users to access their calendars from any computer or mobile device, and to also share information with other users. However, in other embodiments, the calendar application 228 can be a networked calendar application, or hosted locally at the user system 212. The calendar application 228 can vary depending on the implementation, and may be implemented by an existing calendar application, such as iCal™, Mozilla™ Sunbird, Windows™ Live Calendar, Google™ Calendar, Microsoft™ Office 365, Microsoft™ Outlook with Exchange Server, Salesforce.com Calendar, or using various features thereof.

The calendar application 228 can be customized by the user or administrator. Users can use the calendar application 228 to create and maintain various electronic calendars for each user. For example, a given user might have a work calendar, different group calendars within their work calendar, a personal calendar, children's calendar, etc. For example, a group calendar can be used to display calendar events for certain groups that a user is involved in at work. A user can combine and merge different calendars together to gain a better picture of all events on all calendars.

The calendar application 228 can display each calendar showing dates and days of the week with various time slots for each day. The user can view a particular calendar by hourly view, work day view, full day view, work week view, full week view, month view, etc. The calendar application 228 includes an address book or list of contacts with information to enable a user to communicate with the contacts. The calendar application 228 also includes appointment functionality such as an appointment or meeting calendar that includes a list of appointments and the attendees for the appointments. In some implementations, the calendar application 228 can detect scheduling conflicts, notifying the participants of the conflict, and suggesting alternate meeting times. The calendar application 228 can interface with an electronic mail communication system that interfaces with an appointment calendar to send reminders and notify the attendees of invitations to different calendar events (e.g., meetings), send reminders regarding a scheduled calendar event to attendees, or to notify attendees of any issues arising with scheduled calendar events. The calendar application 228 can automatically provide appointment reminders to remind participants of an upcoming meeting, and also includes an attachment feature that allows users to attach files to an appointment so that those files can be shared with other attendees who are participating in the meeting. To facilitate meeting scheduling among several individuals, the calendar application 228 includes features to that allow users to share their availability with other attendees (where users can select how much detail is shared). The calendar application 228 may include scheduling features that automatically check schedules of all attendees and propose a mutually convenient meeting time to all of the attendees. This allows the invitees to suggest times that will work best for them, allowing the event organizer to pick a meeting time that works best for all of the participants. In addition, the calendar application 228 can include scheduling features that allow users to schedule resources to help facilitate the meeting such as room reservation, on-line meeting scheduling that distributes dial in numbers and URLs for on-line meetings, etc. Depending on the implementation, the calendar application 228 can also include other optional features such as calendar publishing that allows a user to publish select calendar information on a public or private link, and calendar exporting that allows a user to export selected calendars into various file formats.

In accordance with the disclosed embodiments, the calendar application 228 can provide context-sensitive informational overlays that can be displayed in conjunction with a calendar. The calendar application 228 can determine contextual information displayed on or in conjunction with the calendar. This contextual information indicates context for the calendar, and can include calendar data and/or third-party data linked to calendar items that are displayed in the calendar. The calendar data can be, for example, data defined on the calendar, or data defined on items that are displayed in the calendar. The items can include one or more of calendar events and calendarable records being displayed on the calendar.

The context-sensitive informational overlays can be dynamically determined based on calendar data or third-party data linked to calendar items displayed on or in conjunction with a calendar displayed by a calendar application 228. For example, in one embodiment, based on the contextual information, the calendar application 228 can automatically query backend systems 240 to dynamically determine, based on the contextual information, one or more context-sensitive overlays that are pertinent to the calendar in view of the contextual information. The user of user system 212 can then be presented (via the calendar UI 214) with an option to display the overlay(s) with the calendar in conjunction with the calendar. These context-sensitive informational overlays can then be displayed in conjunction with the calendar to provide the user with access to supplemental information related to the calendar that would not normally be viewable by or accessible to the user on the calendar (in absence of the overlay) so that the user can view and otherwise interact with the supplemental information that is part of an overlay that is displayed in conjunction with the calendar. For example, in one embodiment, the context-sensitive overlay(s) can be displayed via the user system as a graphical user interface (GUI) element that is superimposed on the calendar to provide supplemental information that is related to the contextual information and enhances the calendar. The user can interact with (e.g., point-and-click) certain elements of the overlay to view and interact with supplemental information that relates to the calendar. This supplemental information that is displayed as part of the overlay can be pulled in from various database systems 230 and backend systems 240.

The application platform 210 includes an associative rule generator 250 that can apply various association rule-learning algorithms 252 to create associative rules that are used to create overlays for calendars that are generated by the calendar application 228 and displayed at the calendar UI 214. In addition, the other backend systems 232 can each include various association rule-learning algorithms 234 to create associative rules that are used to create overlays for calendars. These associative rules can be stored at a repository 240 or database for stored associative rules 242 that can be accessed by the calendar application 228 and/or the various association rule-learning algorithms 234, 252. Each of the stored associative rules 242 has a corresponding overlay that can be generated based on that stored associative rule 242.

As used herein, a rule-learning algorithm can refer to a computer implemented program that is capable of processing calendar information (e.g., calendar data, the calendar items, or the third-party data linked to the calendar items that are displayed on the calendar) from a particular calendar, and identifying characteristics (e.g., patterns) associated with that calendar information to identify one or more overlays that are of potential interest to an end user. In some embodiments, the rule-learning algorithm can also process other information to automatically identify characteristics (e.g., patterns) shared between the calendar information and the other information that can be used to identify one or more overlays that are of potential interest to an end user.

An association rule-learning algorithm is a specific type of rule-learning algorithm. An association rule-learning algorithm can generate associative rules (sometimes also referred to as association rules) based on patterns identified in data that define associations or connections between different data points. The patterns describe how certain data points lead to, or are associated with, other data points. As used herein, an “association rule-learning algorithm” can refer to a computer implemented program that is capable of processing calendar information (e.g., calendar data, the calendar items, or the third-party data linked to the calendar items that are displayed on the calendar) from a particular calendar, identifying characteristics (e.g., patterns) associated with that calendar information, and generating associative rules that can be used to generate context-sensitive overlays that are of potential interest to an end user.

As used herein, an associative rule describes a pattern that links one or more data points together with one or more other data points so that they are associated and thus form an associative rule. In accordance with the disclosed embodiments, each associative rule describes a pattern that links certain calendar information data points together so that they are associated with an overlay (i.e., other data points). As such, calendar information from a calendar can be evaluated against each associative rule and if the calendar information associated with that calendar satisfies or matches a pattern defined by that associative rule a suggested overlay for that calendar can be generated by the calendar application so that a user can consider the suggested overlay for inclusion in the calendar. For example, a rule-learning algorithm could analyze lead information and determine that multiple leads belong to the same company, and generate an associative rule that associates other information about that company (e.g., the company's hours of operation) with the lead information. This associative rule can then be used display the company's hours of operation as an overlay on the lead calendar.

The cloud computing platform 200 and other backend systems 232 can use the association rule-learning algorithms 252, 234 to process contextual information by looking for patterns in the contextual information, and once the patterns are identified/defined each pattern can be stored one or more associative rules. The cloud computing platform 200 and other backend systems 232 can use association rule-learning algorithms 252, 234 to process contextual information and associated overlays submitted from all user's calendars, create associative rules, and store the associative rules 242 in a repository 240 so that associative rules that can be utilized by all users of the system any time new contextual information from a calendar of a particular user is submitted in an attempt to find or create overlays for that calendar. This way the repository 240 can maintain a database of frequently used associative rules 242 and their corresponding overlays. The cloud computing platform 200 and/or other backend systems 232 can prioritize or order these stored associative rules 242 based on frequency of use in all calendars by all users to maintain a prioritized list of associative rules 242 and their corresponding overlays.

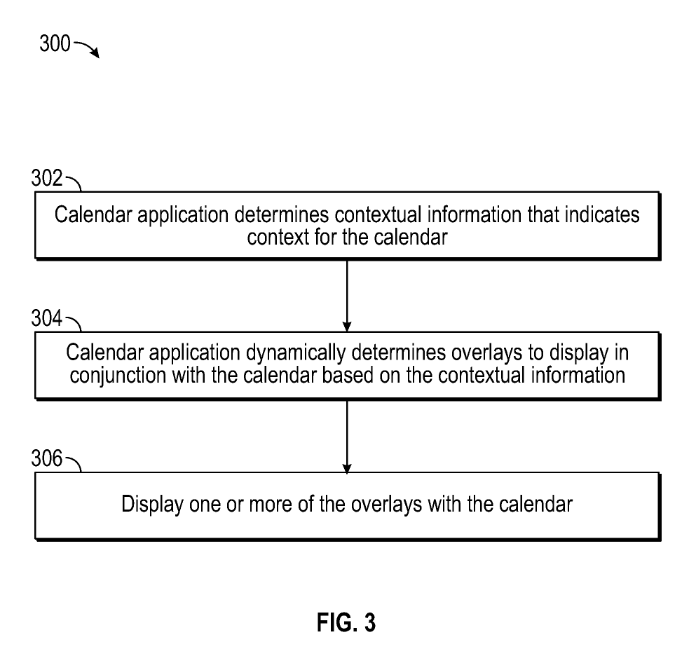

Various events or tasks performed by the various elements in FIG. 2 will be described in greater detail below with reference to FIGS. 3-12. For example, certain operations performed at or by the user systems 212, the application platform 210 and the calendar application 228, the database systems 230 and the other backend systems 240 will be described below. In that regard, FIGS. 3-12 will be described with continued reference to FIG. 2.

FIG. 3 is a flow chart that illustrates an exemplary method 300 for generating and displaying an overlay in conjunction with a calendar displayed by a calendar application 228 in accordance with the disclosed embodiments.

The method 300 begins at 302, where the calendar application 228 determines contextual information displayed on the calendar that indicates context for the calendar. As described above “contextual information” can refer to calendar data or third-party data. Contextual information can include context sensitive metadata. In this regard, calendar data can include, for example, data defined on the calendar (e.g., data backing the calendar that is used to properly display the calendar, retrieve the items to display on the calendar and/or to generally interact with the calendar). Calendar data can also include data defined on items that are displayed in the calendar, where items can calendar events and/or calendarable records being displayed on the calendar. Data defined on the items that are displayed in the calendar can include events or records that are linked to a calendar. Events or records can be any piece of data that contain the minimum requirements to be displayed on a calendar. The requirements are at least one date/time datum of the data in a format allowing to be used to position the data on the calendar relative to the time displayed on the calendar. The event may contain more data not specifically required by the minimum requirements for being displayed on a calendar. An example is displaying credit card purchases on a calendar. The date/time of a purchase would be the only thing needed to place the purchase on the calendar, but there may be other information that it useful for an overlay, such as the place it was purchased, how much money was spent, who made the purchase, etc. Third-party data can include data linked to calendar items that are associated with and/or displayed in the calendar. Third-party data can include any information collected or stored about an event or a record by an entity that does not have a direct relationship with the event/record the data is being collected on.

At 304, the calendar application 228 dynamically determines, based on the contextual information, one or more overlays to be displayed in conjunction with the calendar. At 306, the calendar application 228 displays the calendar with the overlay. Thus, in accordance with the disclosed embodiments, the overlay(s) can be dynamically determined, for example, based on calendar data and/or third-party data linked to the calendar's data. As such, overlays can be targeted to what the user is viewing on the calendar. This can allow the user to make better decisions and increase their chances of having more effective meetings.

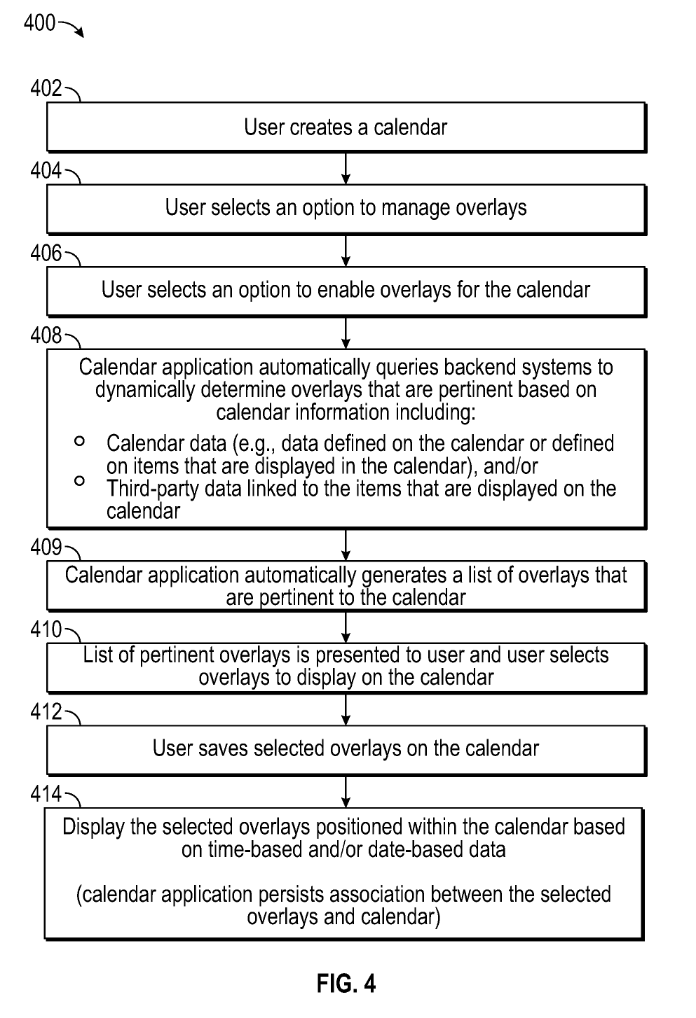

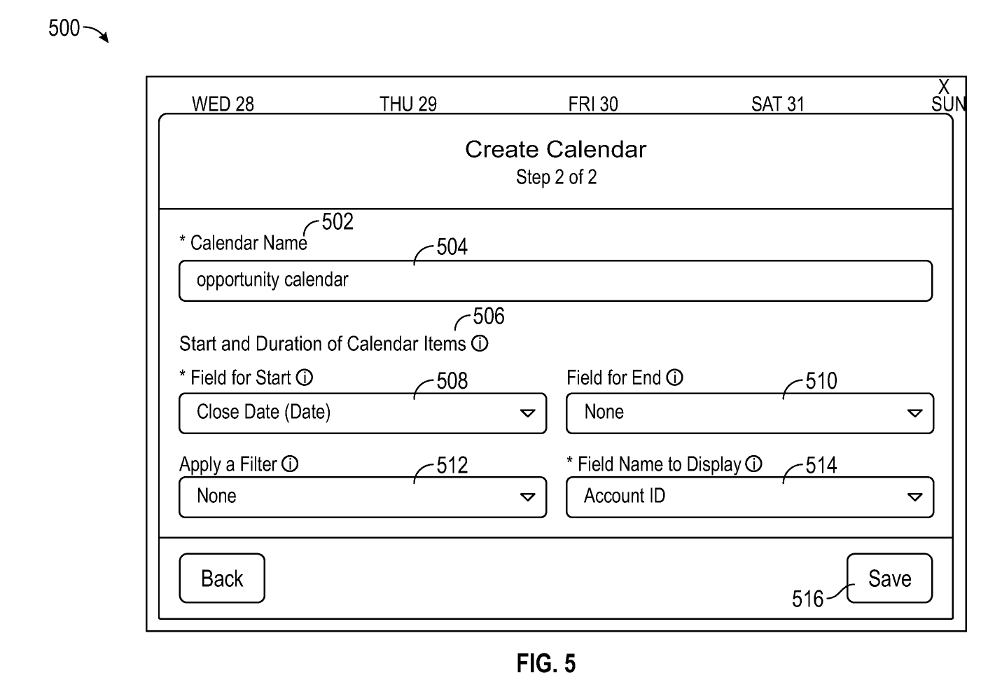

FIG. 4 is a flow chart that illustrates an exemplary method for providing context-sensitive overlays for a calendar application 228 in accordance with the disclosed embodiments. As a preliminary matter, it should be understood that steps of the method 400 are not necessarily limiting, and that steps can be added, omitted, and/or performed simultaneously without departing from the scope of the appended claims. It should be appreciated that the method 400 may include any number of additional or alternative tasks, that the tasks shown in FIG. 4 need not be performed in the illustrated order, and that the method 400 may be incorporated into a more comprehensive procedure or process having additional functionality not described in detail herein. Moreover, one or more of the tasks shown in FIG. 4 could potentially be omitted from an embodiment of the method 400 as long as the intended overall functionality remains intact. It should also be understood that the illustrated method 400 can be stopped at any time. The method 400 is computer-implemented in that various tasks or steps that are performed in connection with the method 400 may be performed by software, hardware, firmware, or any combination thereof. For illustrative purposes, the following description of the method 400 may refer to elements mentioned above in connection with FIG. 4. In certain embodiments, some or all steps of this process, and/or substantially equivalent steps, are performed by execution of processor-readable instructions stored or included on a processor-readable medium. For instance, in the description of FIG. 4 that follows, the user system 212, the cloud-based computing platform 200 the application platform 210, the calendar application 228, the database system(s) 230, and the other backend systems 240 can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIG. 4, a particular example is described in which a user of a user system performs certain actions by interacting with other elements of the system via the user system. Various acts, tasks or steps FIG. 4 will be described below with reference to FIGS. 5-12.

The method 400 begins at 402 when a user creates a calendar or accesses an existing calendar. In one embodiment, the calendar can be a calendar based on a type of record. As used herein, the term “record” refers to an instance of a data object created by a user or administrator of a database service, for example, about a particular (actual or potential) business relationship or project. The data object can have a data structure defined by the database service (a standard object) or defined by a subscriber (custom object). Some non-limiting examples of calenderable records can include things such as events, opportunities, tasks, contacts, cases, accounts, leads, etc. For instance, an opportunity can correspond to a sales prospect, marketing project, or other business related activity with respect to which a user desires to collaborate with others.

FIG. 5 illustrates a screenshot that shows an example of a calendar creation page 500 for creating calendar in a calendaring application in accordance with the disclosed embodiments. The calendar creation page 500 includes a calendar name 502 with a field 504 where the name of the calendar can be entered by the user. The calendar creation page 500 also includes an area 506 that allows a user to enter start and end dates for the calendar. For example, a drop-down menu 508 allows the user to specify a starting date for the calendar, and another drop-down menu 510 allows the user to specify and ending date for the calendar. Drop-down menu 512 allows user to select and apply a filter to the calendar. Drop-down menu 514 allows the user to select a field name to display for the calendar. When the user is done creating the calendar, the user can select the save button 514 and creation the calendar will be complete.

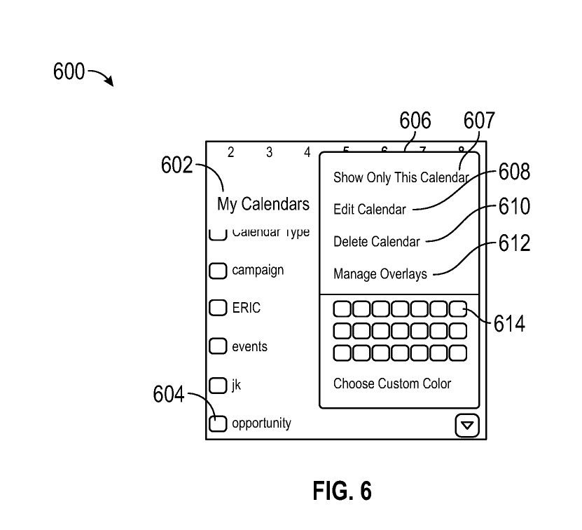

FIG. 6 illustrates a screenshot that shows an example of a calendar selection tab 600 for selecting different calendars in a calendar application 228 in accordance with the disclosed embodiments. A user can use the calendar selection tab 600 to selects one of their calendars in the calendar application 228, and set certain properties for the selected calendar. For example, when a user selects the calendar selection tab 600, a list 602 of the user's calendars is displayed. When the user selects one of the calendars in the list 602 (for example, by hovering over the UI element that represents that calendar in the list 602), a pop-up window 606 will appear that allows the user to control and set certain properties for that calendar. In the example illustrated in FIG. 6, the user has selected an opportunity calendar 604, for example, by hovering over that option in the list 602. The pop-up window 606 allows the user to specify certain information for the opportunity calendar 604. For instance, the user can select an option 607 that allows the user to only show the opportunity calendar 604, can select an option 608 that allows the user to edit the opportunity calendar 604, can select an option 610 that allows the user to delete the opportunity calendar 604, can select an option 612 that allows the user to manage overlays associated with the opportunity calendar 604, and can select a color for the opportunity calendar 604 via panel 614.

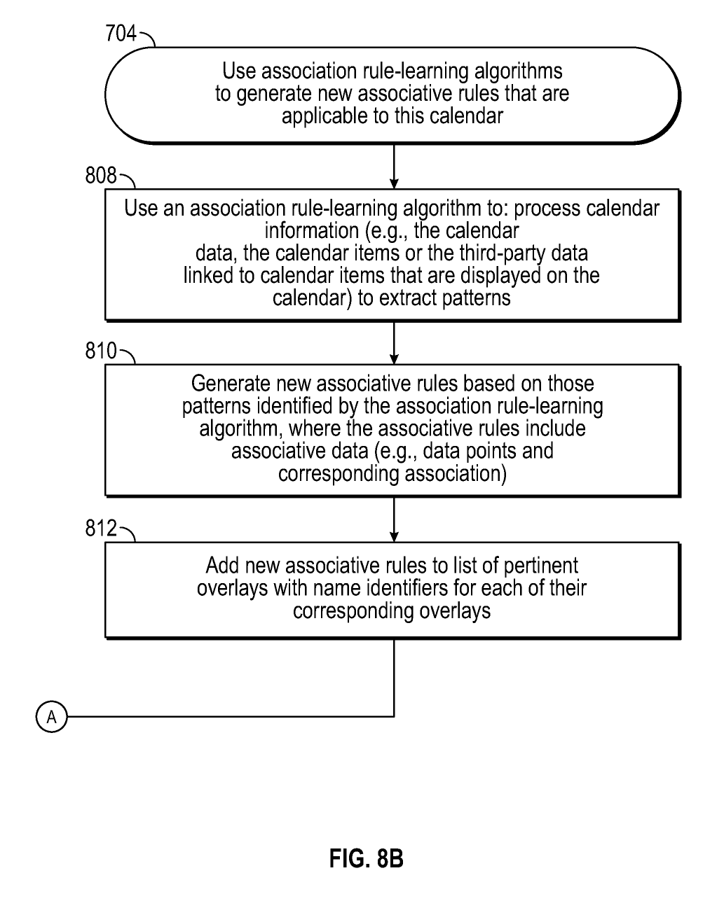

Referring again to FIG. 4, at 404, user selects an option 612 to manage overlays for the calendar. At 406, user enables overlays for the calendar. For example, upon selecting an option to manage overlays, the user will be presented a way to enable/disable overlays associated with a particular calendar. An example will be described below with reference to FIG. 9. Notably, a user can have different calendars with completely different overlays and have them displayed at different times.

At 408, the calendar application 228 automatically queries backend systems to dynamically determine overlays that are pertinent to the calendar. The overlays can be determined or automatically created based on contextual information from the calendar. The contextual information can include, for example, calendar data or third-party data linked to items (e.g., events/records) that are displayed on the calendar. The calendar data can be, for example, data defined on the calendar, and/or data defined based on items (e.g., events/records) that are displayed in the calendar. An example of third-party data would be in a calendar containing events about different leads a link could be made to publicly available information about the company the lead belongs to.

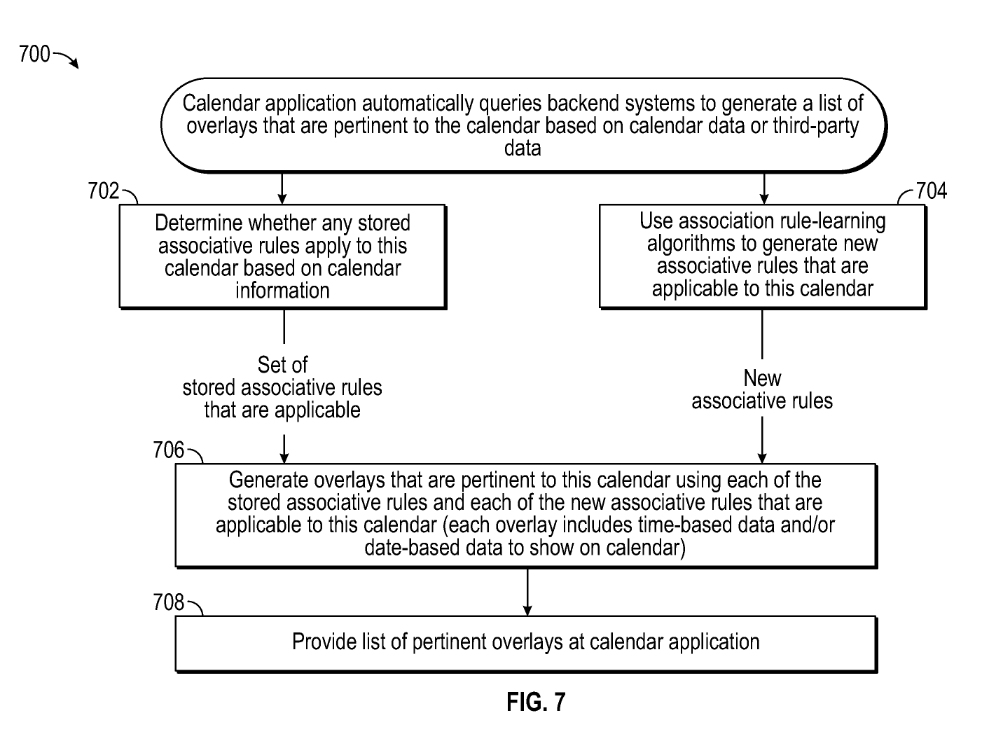

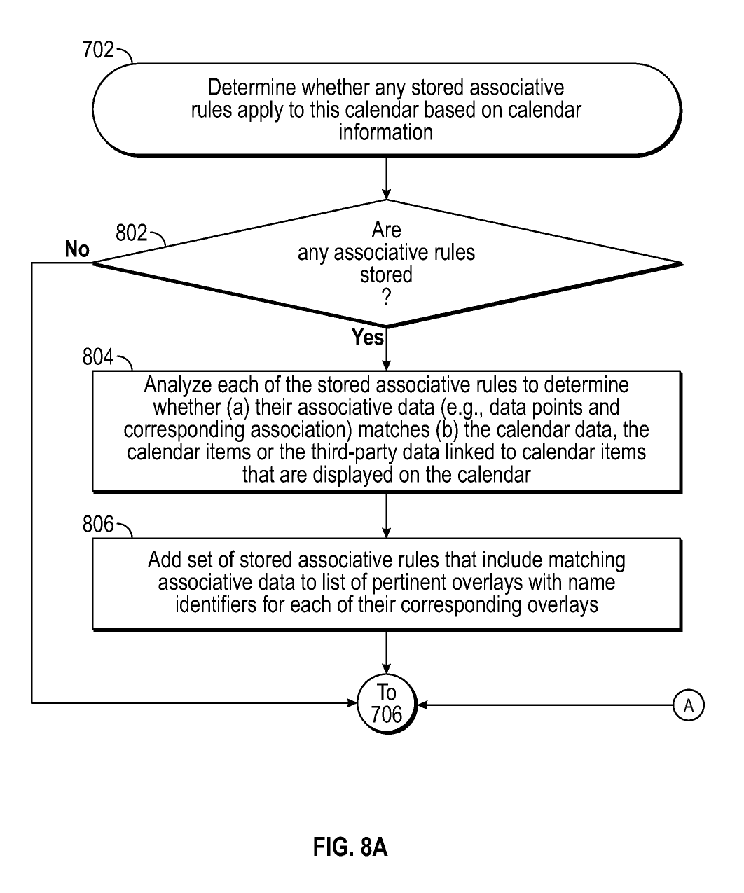

In one embodiment of 408, the calendar application 228 can query the backend systems to directly or indirectly determine whether any information regarding existing overlays is stored for this calendar and can add any of the existing overlays that are determined to be pertinent to the list of pertinent overlays. If no existing overlays are available for this calendar the list of pertinent overlays will remain empty. In addition, the calendar application 228 can also attempt to create new overlays to be added to the list of pertinent overlays. For example, in one embodiment, the calendar application 228 can determine other overlays that are applicable to the calendar (and that are to be added to the list of pertinent overlays for this calendar) based on associative rules and data regarding frequency of use in other calendars by other users, and can add the other “new” overlays that are determined to be applicable for this calendar to the list of pertinent overlays. As such, in accordance with the disclosed embodiments, the frequency of the data, from the associative rules, being used in other user's calendar's overlay(s) can be used to determine new overlays applicable for a calendar. One exemplary embodiment of step 408 will be described below with reference to FIGS. 7, 8A and 8B to provide an example of a process for generating the list of pertinent overlays.

At 409, the calendar application generates a list of overlays that are pertinent to the calendar, and at 410, the calendar application 228 presents the list of pertinent overlays to the user via the calendar user interface, and the user can select one or more of the pertinent overlays to display on the calendar.

At 412, when the user is finished selecting the pertinent overlays that the user wishes to display with the calendar, the user saves the selected overlays. At 414, once the selected, pertinent overlays are saved, the selected overlays are displayed on the calendar. For example, the selected overlays can be superimposed on the regular or normal calendar UI. In some embodiments, each overlay is associated with the calendar meaning that the calendar application 228 will persist the association between the selected overlays and calendar. For example, the selected, pertinent overlays will be displayed whenever the calendar is displayed, will be hidden (or not displayed) when the calendar is hidden, and will be shared when the calendar is shared. This way the user will see the overlay upon returning back to view the calendar, and if the calendar is shared with other users it will also share the associated overlays. By contrast, in conventional calendaring systems that have overlays, an overlay is associated with the user's account and the visible date range. As such, although sharing of calendars might be allowed, the overlays will not be shared, which means that a user can see the items on a calendar that has been shared, but not the associated overlays that could provide them with useful information.

FIG. 7 is a flow chart that illustrates an exemplary method 700 for automatically querying backend systems to generate a list of overlays that are pertinent to a calendar based on contextual information in accordance with the disclosed embodiments. It should be appreciated that the method 700 may include any number of additional or alternative tasks, that the tasks shown in FIG. 7 need not be performed in the illustrated order, and that the method 700 may be incorporated into a more comprehensive procedure or process having additional functionality not described in detail herein. Moreover, one or more of the tasks shown in FIG. 7 could potentially be omitted from an embodiment of the method 700 as long as the intended overall functionality remains intact.

Prior to method 700, the backend systems 232 use the association rule-learning algorithms 234 to process contextual information by looking for patterns in the contextual information, and once the patterns are identified/defined each pattern can be stored one or more associative rules 242. The backend systems 232 can use association rule-learning algorithms 234 to process contextual information and associated overlays submitted from all user's calendars, create associative rules, and store the associative rules 242 in a repository 240 so that associative rules that can be utilized by all users of the system any time new contextual information from a calendar of a particular user is submitted in an attempt to create overlays for that calendar. This way the repository 240 can maintain a database of frequently used associative rules 242 and their corresponding overlays. The backend systems 232 can prioritize or order these stored associative rules 242 based on frequency of use in all calendars by all users to maintain a prioritized list of associative rules 242 and their corresponding overlays.

At 702, the calendar application 228 can determine whether any stored associative rules 242 apply to this calendar based on contextual information, and identify a set of the stored associative rules that are applicable to the calendar. One embodiment of 702 will be described in greater detail below with reference to FIG. 8A.

At 704, the calendar application 228 use one or more association rule-learning algorithms 234, 252 to generate new associative rules that are applicable to this calendar. One embodiment of 704 will be described in greater detail below with reference to FIG. 8B.

At 706, the calendar application 228 can then use the set of the stored associative rules (generated at 702) and any new associative rules that are applicable to the calendar (generated at 704) to create or generate overlays that are pertinent to the calendar. Each overlay that is generated can include (1) a unique identifier that identifies the overlay to the calendaring application 228 and a link to the calendar, (2) a unique human-readable (e.g., text based) identifier that identifies the overlay to a user (human) in a meaningful away (e.g., title, name or subject identifier for each of those overlays that can be presented to the user via the user interface), (3) time-based data and/or date-based data (e.g., one or more of time and date data that can be used to specify start and end times for the overlay) that indicate placement of the overlay within the calendar, and (4) any other information or content needed to present the overlay. In addition, information can be included so that a user can visually differentiate between different overlays. For instance, if two or more overlays overlap based on time or date, information can be provided that allows the calendar application to provide visually differentiation between the two such as different color or pattern options. Each overlay can include automated display controls so that if the corresponding calendar is currently set to invisible by the user the calendar application will automatically make the overlay invisible as well. Likewise, if the corresponding calendar is currently set to visible by the user the calendar application will automatically make the overlay visible as well.

At 708, the calendar application 228 can add all of the pertinent overlays to a list, and then display the list of pertinent overlays to the user via a user interface of the calendar application. The list of pertinent overlays can be presented to the user using the unique human-readable identifiers that identifies each pertinent overlay. At noted above, in one embodiment, these can be text-based name identifiers for each of the pertinent overlays.

FIGS. 8A and 8B collectively illustrate a flow chart of an exemplary method 800 for identifying a set of the stored associative rules 242 and generating new associative rules that are applicable to a calendar in accordance with the disclosed embodiments. In particular, FIG. 8A illustrates one example implementation of a method 800 that includes steps 802/804/806 that can be used to perform step 702 of FIG. 7, and FIG. 8B illustrates steps 808/810/812 that can be used to perform step 704 of FIG. 7. It should be appreciated that the method 800 may include any number of additional or alternative tasks, that the tasks shown in FIGS. 8A and 8B need not be performed in the illustrated order, and that the method 800 may be incorporated into a more comprehensive procedure or process having additional functionality not described in detail herein. Moreover, one or more of the tasks shown in FIGS. 8A and 8B could potentially be omitted from an embodiment of the method 800 as long as the intended overall functionality remains intact.

In one embodiment, when overlays are enabled (at 406 of FIG. 4), the calendar application 228 can determine whether any stored associative rules apply to this calendar based on the contextual information. Depending on the implementation, these associative rules could be stored locally at the user system and/or externally in a database at a backend system. The stored associative rules can include previously created rules that are associated with the user's previously created calendars and/or previously created rules that are associated with other user's calendars. Associative rules allow the calendar application to determine potential overlays that are candidates for display on the calendar. In one embodiment, to determine if any applicable associative rules are stored, at 802 the calendar application 228 can send new contextual information to a backend system (as a query), and the backend system can determine if any associative rules are stored, and start processing to determine if any of the “stored” associative rules apply to that new contextual information. When no any associative rules are stored, the method 800 proceeds from 802 to 706 of FIG. 7.

At 804, for any associative rules that are stored, the calendar application 228 or the backend system can analyze each of the stored associative rules to determine whether the associative data (e.g., a pattern defined by data points and corresponding association) for that associative rule matches contextual information (e.g., the calendar data, the calendar items and/or the third-party data linked to calendar items that are displayed on the calendar). Each associative rule is pattern that is made up of associative data that includes data points and a corresponding association that is associated with those data points.

For example, in one implementation of 804, a processor at the backend system can evaluate the new contextual information against the associative rule by running a check to see if the new contextual information matches a pattern specified by that associative rule. If the new contextual information matches the pattern specified by associative data for that associative rule, then that associative rule and its corresponding overlay will be identified as being pertinent and added to a list of pertinent overlays that is returned to the calendar application (at 806). If the new contextual information does not match the pattern specified by associative data for that associative rule, then that associative rule does not apply and the corresponding overlay associated with that stored associative rule is not pertinent to the calendar and is not added to a list of pertinent overlays that is returned to the calendar application.

In some embodiments, the contextual information must identically match the associative data for that associative rule in order for that associative rule (and its corresponding overlay) to be identified as being pertinent and added to a list of pertinent overlays.

In other embodiments, an exact or identical match is not required for that associative rule to be identified as being pertinent. Rather, an associative rule (and its corresponding overlay) can be identified as being pertinent (and added to a list of pertinent overlays) if there is a requisite degree of similarity between the contextual information and the associative data. In some embodiments, the “requisite degree of similarity” can be defined or configured by the system administrator for each user or organization based on what they perceive as a strong association between any number of instances of contextual information and the associative data for a given associative rule. The end user has the option to select the overlays that they want to be displayed on the calendar, and therefore if an overlay is suggested by its inclusion on the list of pertinent overlays, the user can still leave that particular overlay unselected so that it is not displayed on their calendar. In one implementation, at 804, each associative rule can be evaluated by comparing the definitions and the records from the associative rule to the calendar data, the calendar items or the third-party data linked to the calendar items that are displayed on the calendar, and if they are sufficiently similar, a match is found.

At 806, the set of stored associative rules (i.e., that include matching associative data) can be added to the list of pertinent overlays. The list of pertinent overlays can include name identifiers for each of the overlays that correspond to one of the stored associative rules that was determined to have matching associative data. For example, in one embodiment, the backend system can compile a list that includes each of the matching associative rules (e.g., that had a pattern matching the calendar data), and can then generate a list of pertinent overlays that includes a name identifier for each overlay that corresponds to one of the matching associative rules. The method 800 then proceeds to 706 of FIG. 7.

As described above with reference to 704 (FIG. 7), the calendar application 228 can also create or generate new associative rules (and corresponding overlays) that are applicable to this calendar using use one or more association rule-learning algorithms that can be implemented at the calendar application or at backend systems that work in conjunction with the calendar application. In this embodiment, at 808, one or more association rule-learning algorithm(s) can be used to process new contextual information (e.g., the calendar data, the calendar items or the third-party data linked to calendar items that are displayed on the calendar) to extract/identify new patterns from that contextual information.

Using the patterns that were extracted at 808, the association rule-learning algorithm(s) 234, 252 can generate and store, at 810, new associative rules for each new pattern that satisfies some association strength criteria or constraints needed for creation of an associative rule such as a certain number of data points in common with the calendar information. In other words, in some implementations, every pattern detected from the contextual information will not necessarily trigger generation of a new associative rule. Further, it is noted that not every associative rule will necessarily generate an overlay, and that some associative rules are used as links between other associative rules such that calendar information might could result in generation of an associative rule that links to another associative rule that results in an overlay being generated for that calendar information. Each new associative rule includes associative data (e.g., data points and corresponding association that is associated with those data points and reflects a pattern), and corresponds to an overlay having a name identifier.

At 812, each of the new associative rules and their corresponding overlays can be added to the list of pertinent overlays. For example, in one embodiment, the list of pertinent overlays can include name identifiers for each of the overlays that correspond to one of the new associative rules that were generated by the association rule-learning algorithm(s) at 810. For example, the backend system can compile a list that includes each of the new associative rules (from 810), and can then generate a list of pertinent overlays that includes a name identifier for each overlay that corresponds to one of the new associative rules. The method 800 then proceeds to 706 of FIG. 7.

FIG. 9 illustrates a screenshot 900 that shows one example of an overlay management screen that can be used to manage which overlays are displayed on a calendar of a calendaring application in accordance with the disclosed embodiments. In this particular non-limiting example, three overlays 902, 904, 906 that are available are presented to a user in a dialog. The user can select any of the overlays 902, 904, 906 that the user wants to be displayed (by marking a check box, for example). In this example, the stock market hours overlay 904 is selected (via check box) and if the user selects the button labeled display check overlays 908 while the stock market hours overlay 904 is selected, then the stock market hours overlay 904 will be displayed on the calendar. Likewise, if the end of financial quarter overlay 902 or the east coast banking hours overlay 906 is selected (via respective check boxes) and if the user selects the button labeled display check overlays 908 while those overlays 902, 906 are selected, then the end of financial quarter overlay 902 or the east coast banking hours overlay 906 would be displayed on the calendar. In addition, in this example, the user has scrolled over the end of financial quarter overlay 902 (such that it appears highlighted). This causes details for the end of financial quarter overlay 902 to be displayed regarding the end of financial quarter overlay 902 including name 910, display format 912 (e.g., here it is a line), a check box option 914 for whether it is to be repeating (when check box is selected), a next date/time 916 it will be displayed (here 01/31/2017 4 pm PST), and a check box option 918 to recommend this overlay from other similar calendars (e.g., this overlay was recommended to you because it is popular with other people with similar calendars). These details are configurable and can be include other detail fields that are not illustrated in FIG. 9.

Once the user selects (at 410 of FIG. 4) and saves the selected overlays on the calendar (at 412 of FIG. 4), those overlays will be displayed on the calendar as described above with reference to 414 of FIG. 4. The format of the overlays can vary depending on the implementation, and other factors such as the type of time-based data and/or date-based data being displayed. The time-based data and date-based data can have one of five different formats: specific date-only (e.g., a single point in time with only a date such as company holidays, 01/02/2017); specific date and specific time (e.g., a single point in time with a date and a time such as end of the financial quarter, 12/01/2016 4 pm PST); date-only range (e.g., a date only range such as Planned Time Off, 01/01/2017-01/03/2017); date-based range and time-based range (e.g., a date and time based range such as opening and closing hours for the New York Stock Exchange, 01/02/2017 8 am-01/02/2017 2 pm PST)); or time-based range (e.g., lunch time, 12 pm-1 pm PST). In one embodiment, the date-based data and time-based data can also be recurring data. In another embodiment, the date-based data and time-based data can also be point in time data on a date range that is visible to the user (e.g., day, week, month, etc.).

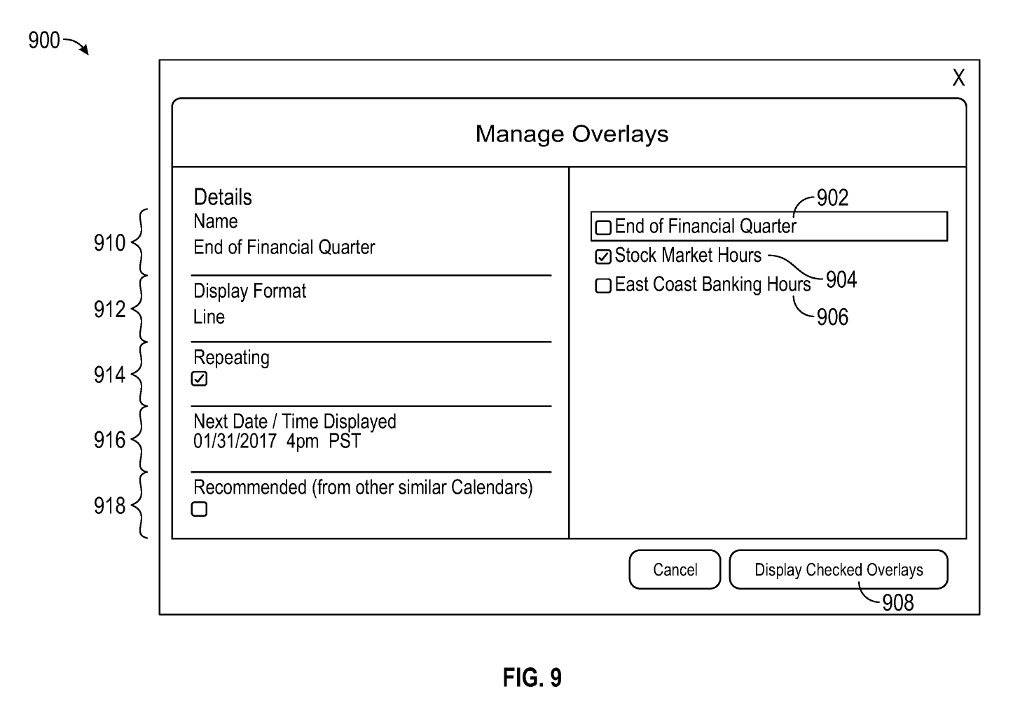

Three examples of overlays that can be displayed via the calendar user interface will now be described below with reference to FIGS. 10-12.

FIG. 10 illustrates a screenshot 1000 that shows one example of an overlay 1002 displayed on a portion of a calendar 1004 of a calendaring application in accordance with the disclosed embodiments. In this particular non-limiting example, a portion of a calendar 1004 for Sunday the 25^{th} is shown between the hours of 5:30 AM and 10:30 AM. The overlay 1002 is displayed as a horizontal line at a point in time 8:45 AM (e.g., specific date and specific time).

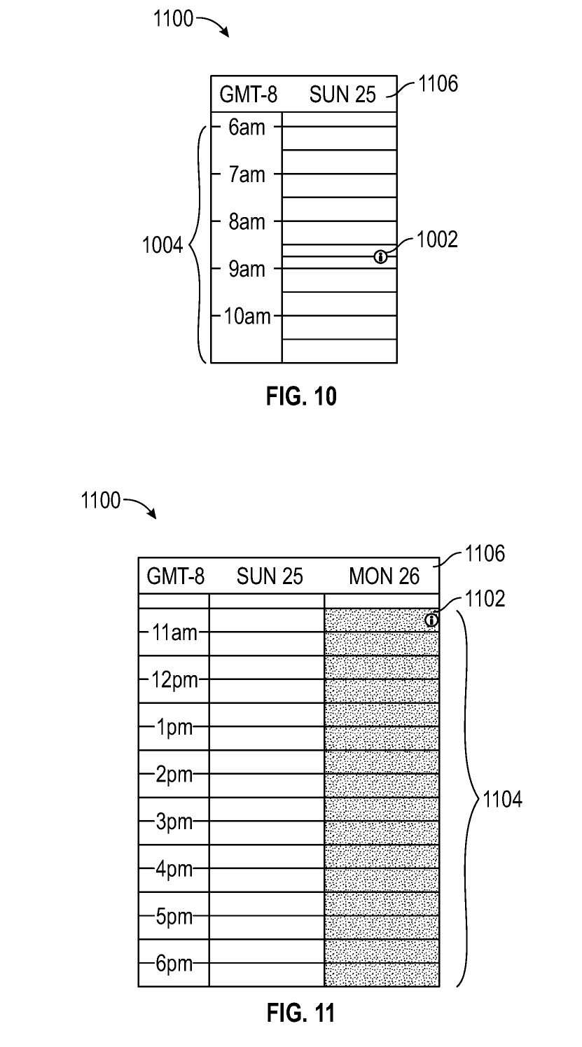

FIG. 11 illustrates a screenshot 1100 that shows one example of an overlay 1102 displayed on a portion of a calendar 1104 of a calendaring application in accordance with the disclosed embodiments. In this particular non-limiting example, a portion of a calendar 1104 for Monday the 26^{th} is shown between the hours of 10 AM and 6 PM. Here, the overlay 1102 is displayed as a background block that represents a time-based range from 11 AM to 6 PM on a specific day (e.g., a time-based range).

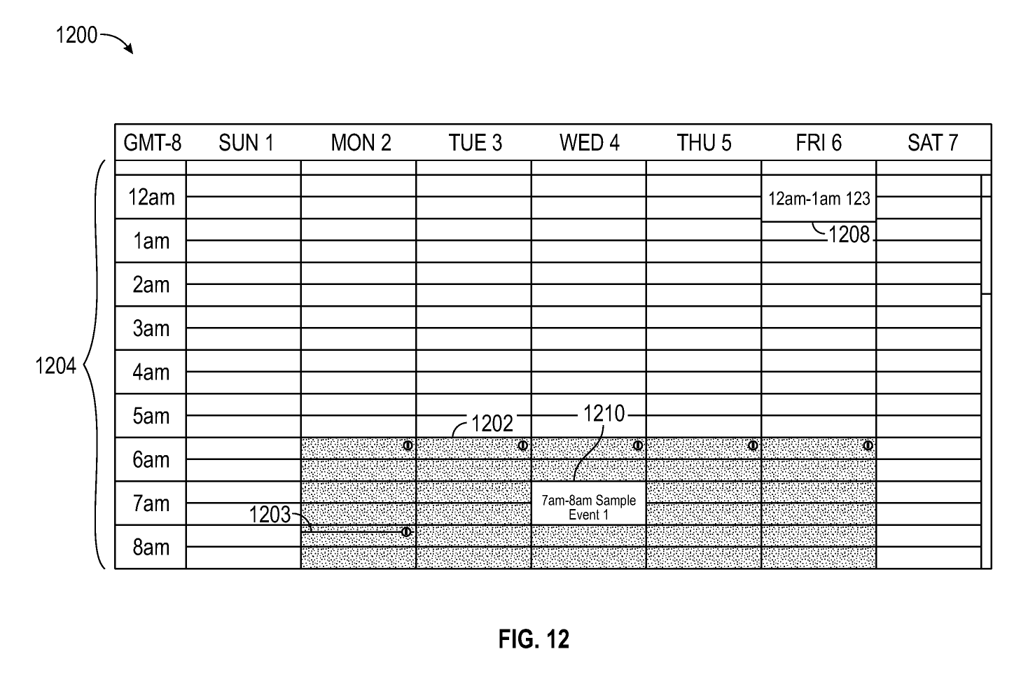

FIG. 12 illustrates a screenshot 1200 that shows other examples of overlays 1202, 1203 that can be displayed on a portion of a calendar 1204 of a calendaring application in accordance with the disclosed embodiments. In this particular non-limiting example, a portion of a calendar 1204 for a week view from Sunday the 1^{st} to Saturday the 7^{th} is shown between the hours of 11 PM and 9 AM. Here, a time-based range and date-based range overlay 1202 is displayed as a background block that represents a time-based range from 6 AM to 9 AM on each weekday from Monday the 2^{nd} to Friday the 6th, whereas the overlay 1203 is displayed as a horizontal line at a point in time 8:00 AM on Monday the 2^{nd} (e.g., a specific time and a specific date). When the user scrolls over the overlay additional information can be displayed such as a complete time/date range for the overlay, a title for the overlay, and a name or an identifier for the linked calendar. The screenshot 1200 also illustrates two calendar events 1208, 1210 that appear on the calendar 1204.

The overlays can include various types of information that supplement the information provided on the calendar. For example, if the calendar is a record (entity) calendar based on opportunities, a company listed in one of the opportunities can be analyzed to determine when it's financial quarters starts and ends, and that information can be displayed as an overlay on the calendar. This way the user can use this information, for example, to help pick a time for a meeting that is favorable to making a sale with that company.

As another example, if a company is traded on a different stock market or has different business hours, then this information can be displayed as an overlay on the calendar. This type of context sensitive information can be pulled from third party sources and combined with organization data. This information would help salespeople make better decisions about when to have these meetings.

Another example would be in a scenario where a user works with banks in the Eastern time zone of the US, and this information is associated to the user in a backend system. In this example, an overlay can be displayed that includes the banking hours, time zone adjusted.

As another example, a learning algorithm rule could determine, by analyzing lead information, that multiple leads belong to the same company, and then associate that company's hours of operation with the lead information and display the company's hours as an overlay.

These are just a few non-limiting examples of the types of information that can be displayed via an overlay.

The following description is of one example of a system in which the features described above may be implemented. The components of the system described below are merely one example and should not be construed as limiting. The features described above with respect to FIGS. 1-12 may be implemented in any other type of computing environment, such as one with multiple servers, one with a single server, a multi-tenant server environment, a single-tenant server environment, or some combination of the above.

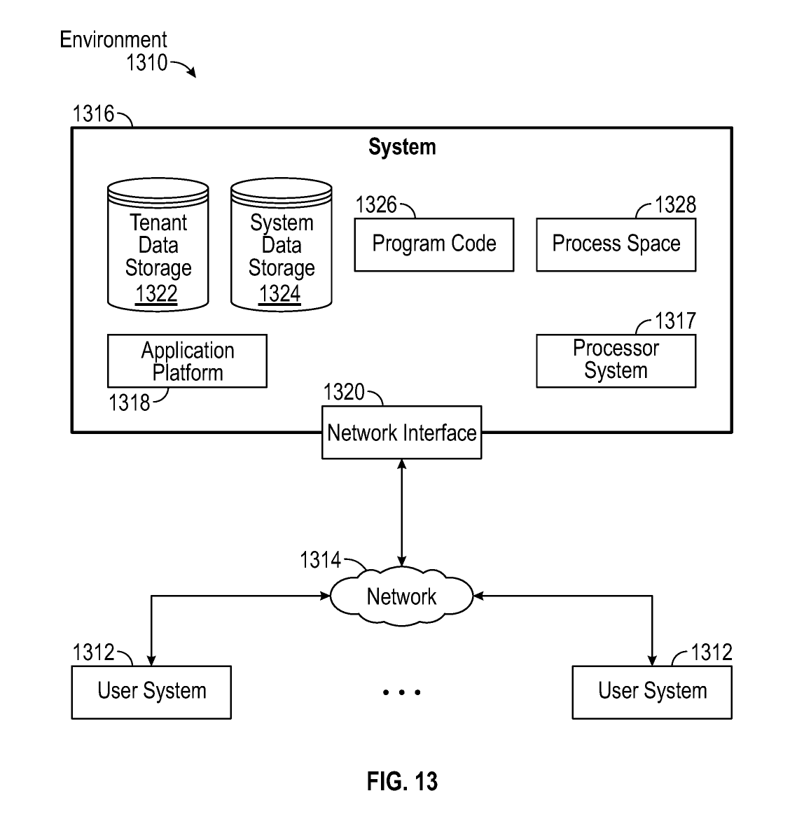

FIG. 13 shows a block diagram of an example of an environment 1310 in which an on-demand database service can be used in accordance with some implementations. The environment 1310 includes user systems 1312, a network 1314, a database system 1316 (also referred to herein as a “cloud-based system”), a processor system 1317, an application platform 1318, a network interface 1320, tenant database 1322 for storing tenant data 1323, system database 1324 for storing system data 1325, program code 1326 for implementing various functions of the system 1316, and process space 1328 for executing database system processes and tenant-specific processes, such as running applications as part of an application hosting service. In some other implementations, environment 1310 may not have all of these components or systems, or may have other components or systems instead of, or in addition to, those listed above.

In some implementations, the environment 1310 is an environment in which an on-demand database service exists. An on-demand database service, such as that which can be implemented using the system 1316, is a service that is made available to users outside of the enterprise(s) that own, maintain or provide access to the system 1316. As described above, such users generally do not need to be concerned with building or maintaining the system 1316. Instead, resources provided by the system 1316 may be available for such users' use when the users need services provided by the system 1316; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 1318 can be a framework that allows the applications of system 1316 to execute, such as the hardware or software infrastructure of the system 1316. In some implementations, the application platform 1318 enables the creation, management and execution of one or more applications developed by the provider of the on-demand database service, users accessing the on-demand database service via user systems 1312, or third party application developers accessing the on-demand database service via user systems 1312.

In some implementations, the system 1316 implements a web-based customer relationship management (CRM) system. For example, in some such implementations, the system 1316 includes application servers configured to implement and execute CRM software applications as well as provide related data, code, forms, renderable web pages and documents and other information to and from user systems 1312 and to store to, and retrieve from, a database system related data, objects, and Web page content. In some MTS implementations, data for multiple tenants may be stored in the same physical database object in tenant database 1322. In some such implementations, tenant data is arranged in the storage medium(s) of tenant database 1322 so that data of one tenant is kept logically separate from that of other tenants so that one tenant does not have access to another tenant's data, unless such data is expressly shared. The system 1316 also implements applications other than, or in addition to, a CRM application. For example, the system 1316 can provide tenant access to multiple hosted (standard and custom) applications, including a CRM application. User (or third party developer) applications, which may or may not include CRM, may be supported by the application platform 1318. The application platform 1318 manages the creation and storage of the applications into one or more database objects and the execution of the applications in one or more virtual machines in the process space of the system 1316.

According to some implementations, each system 1316 is configured to provide web pages, forms, applications, data and media content to user (client) systems 1312 to support the access by user systems 1312 as tenants of system 1316. As such, system 1316 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 1314 can be or include any network or combination of networks of systems or devices that communicate with one another. For example, the network 1314 can be or include any one or any combination of a LAN (local area network), WAN (wide area network), telephone network, wireless network, cellular network, point-to-point network, star network, token ring network, hub network, or other appropriate configuration. The network 1314 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 1312 can communicate with system 1316 using TCP/IP and, at a higher network level, other common Internet protocols to communicate, such as HTTP, FTP, AFS, WAP, etc. In an example where HTTP is used, each user system 1312 can include an HTTP client commonly referred to as a “web browser” or simply a “browser” for sending and receiving HTTP signals to and from an HTTP server of the system 1316. Such an HTTP server can be implemented as the sole network interface 1320 between the system 1316 and the network 1314, but other techniques can be used in addition to or instead of these techniques. In some implementations, the network interface 1320 between the system 1316 and the network 1314 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 1312 can be implemented as any computing device(s) or other data processing apparatus or systems usable by users to access the database system 1316. For example, any of user systems 1312 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 1312 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 1316) of the user system 1312 to access, process and view information, pages and applications available to it from the system 1316 over the network 1314.

Each user system 1312 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 1312 in conjunction with pages, forms, applications and other information provided by the system 1316 or other systems or servers. For example, the user interface device can be used to access data and applications hosted by system 1316, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 1312 may differ in their respective capacities, and the capacity of a particular user system 1312 can be entirely determined by permissions (permission levels) for the current user of such user system. For example, where a salesperson is using a particular user system 1312 to interact with the system 1316, that user system can have the capacities allotted to the salesperson. However, while an administrator is using that user system 1312 to interact with the system 1316, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 1312 and some or all of its components are operator-configurable using applications, such as a browser, including computer code executed using a central processing unit (CPU) such as an Intel Pentium® processor or the like. Similarly, the system 1316 (and additional instances of an MTS, where more than one is present) and all of its components can be operator-configurable using application(s) including computer code to run using the processor system 1317, which may be implemented to include a CPU, which may include an Intel Pentium® processor or the like, or multiple CPUs.

The system 1316 includes tangible computer-readable media having non-transitory instructions stored thereon/in that are executable by or used to program a server or other computing system (or collection of such servers or computing systems) to perform some of the implementation of processes described herein. For example, computer program code 1326 can implement instructions for operating and configuring the system 1316 to intercommunicate and to process web pages, applications and other data and media content as described herein. In some implementations, the computer code 1326 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

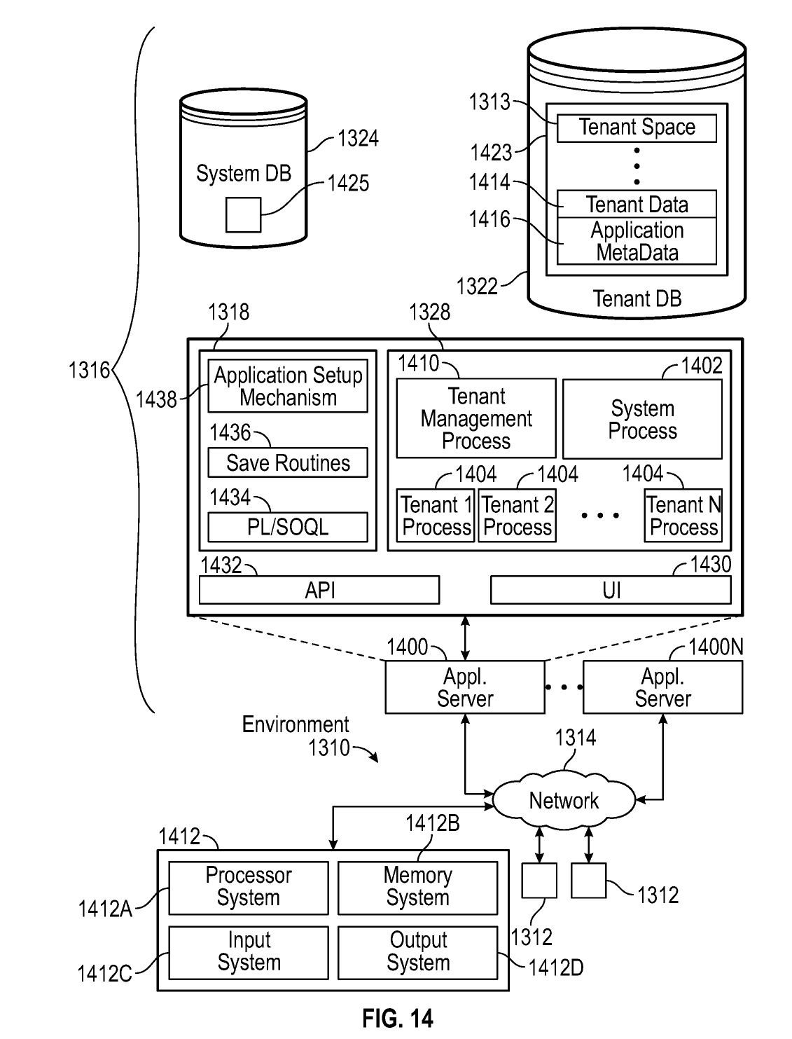

FIG. 14 shows a block diagram of example implementations of elements of FIG. 13 and example interconnections between these elements according to some implementations. That is, FIG. 14 also illustrates environment 1310, but FIG. 14, various elements of the system 1316 and various interconnections between such elements are shown with more specificity according to some more specific implementations. Elements from FIG. 13 that are also shown in FIG. 14 will use the same reference numbers in FIG. 14 as were used in FIG. 13. Additionally, in FIG. 14, the user system 1312 includes a processor system 1412A, a memory system 1412B, an input system 1412C, and an output system 1412D. The processor system 1412A can include any suitable combination of one or more processors. The memory system 1412B can include any suitable combination of one or more memory devices. The input system 1412C can include any suitable combination of input devices, such as one or more touchscreen interfaces, keyboards, mice, trackballs, scanners, cameras, or interfaces to networks. The output system 1412D can include any suitable combination of output devices, such as one or more display devices, printers, or interfaces to networks.

In FIG. 14, the network interface 1320 of FIG. 13 is implemented as a set of HTTP application servers 14001-1400N. Each application server 1400, also referred to herein as an “app server,” is configured to communicate with tenant database 1322 and the tenant data 1423 therein, as well as system database 1324 and the system data 1425 therein, to serve requests received from the user systems 1412. The tenant data 1423 can be divided into individual tenant storage spaces 1413, which can be physically or logically arranged or divided. Within each tenant storage space 1413, tenant data 1414 and application metadata 1416 can similarly be allocated for each user. For example, a copy of a user's most recently used (MRU) items can be stored to user storage 1414. Similarly, a copy of MRU items for an entire organization that is a tenant can be stored to tenant storage space 1413.

The process space 1328 includes system process space 1402, individual tenant process spaces 1404 and a tenant management process space 1410. The application platform 1318 includes an application setup mechanism 1438 that supports application developers' creation and management of applications. Such applications and others can be saved as metadata into tenant database 1322 by save routines 1436 for execution by subscribers as one or more tenant process spaces 1404 managed by tenant management process 1410, for example. Invocations to such applications can be coded using PL/SOQL 1434, which provides a programming language style interface extension to API 1432. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 1316 of FIG. 14 also includes a user interface (UI) 1430 and an application programming interface (API) 1432 to system 1316 resident processes to users or developers at user systems 1412. In some other implementations, the environment 1310 may not have the same elements as those listed above or may have other elements instead of, or in addition to, those listed above.

Each application server 1400 can be communicably coupled with tenant database 1322 and system database 1324, for example, having access to tenant data 1423 and system data 1425, respectively, via a different network connection. For example, one application server 14001 can be coupled via the network 1314 (for example, the Internet), another application server 1400N can be coupled via a direct network link, and another application server (not illustrated) can be coupled by yet a different network connection. Transfer Control Protocol and Internet Protocol (TCP/IP) are examples of typical protocols that can be used for communicating between application servers 1400 and the system 1316. However, it will be apparent to one skilled in the art that other transport protocols can be used to optimize the system 1316 depending on the network interconnections used.

In some implementations, each application server 1400 is configured to handle requests for any user associated with any organization that is a tenant of the system 1316. Because it can be desirable to be able to add and remove application servers 1400 from the server pool at any time and for various reasons, in some implementations there is no server affinity for a user or organization to a specific application server 1400. In some such implementations, an interface system implementing a load balancing function (for example, an F5 Big-IP load balancer) is communicably coupled between the application servers 1400 and the user systems 1412 to distribute requests to the application servers 1400. In one implementation, the load balancer uses a least-connections algorithm to route user requests to the application servers 1400. Other examples of load balancing algorithms, such as round robin and observed-response-time, also can be used. For example, in some instances, three consecutive requests from the same user could hit three different application servers 1400, and three requests from different users could hit the same application server 1400. In this manner, by way of example, system 1316 can be a multi-tenant system in which system 1316 handles storage of, and access to, different objects, data and applications across disparate users and organizations.

In one example storage use case, one tenant can be a company that employs a sales force where each salesperson uses system 1316 to manage aspects of their sales. A user can maintain contact data, leads data, customer follow-up data, performance data, goals and progress data, etc., all applicable to that user's personal sales process (for example, in tenant database 1322). In an example of a MTS arrangement, because all of the data and the applications to access, view, modify, report, transmit, calculate, etc., can be maintained and accessed by a user system 1412 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 1316 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 1316 also can maintain system level data usable by multiple tenants or other data. Such system level data can include industry reports, news, postings, and the like that are sharable among tenants.

In some implementations, the user systems 1412 (which also can be client systems) communicate with the application servers 1400 to request and update system-level and tenant-level data from the system 1316. Such requests and updates can involve sending one or more queries to tenant database 1322 or system database 1324. The system 1316 (for example, an application server 1400 in the system 1316) can automatically generate one or more SQL statements (for example, one or more SQL queries) designed to access the desired information. System database 1324 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

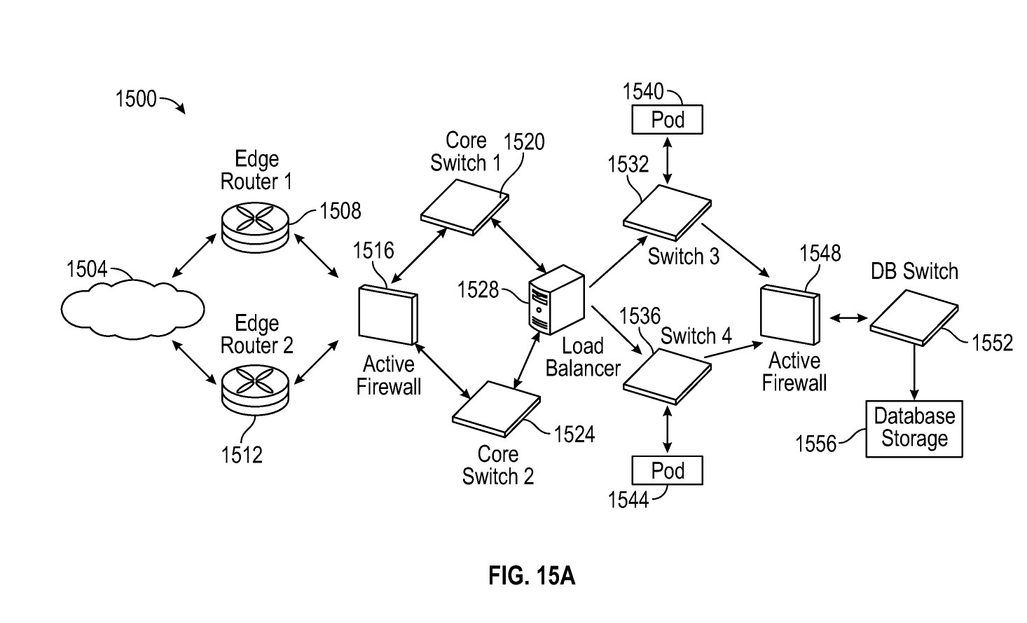

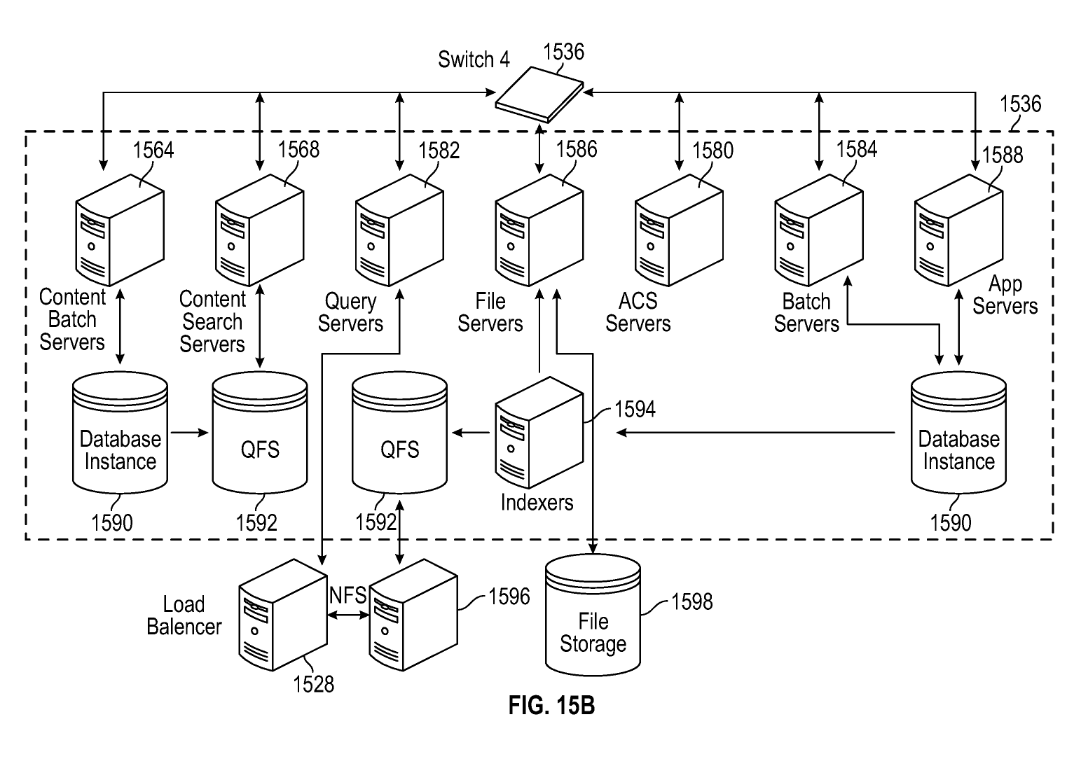

FIG. 15A shows a system diagram illustrating example architectural components of an on-demand database service environment 1500 according to some implementations. A client machine communicably connected with the cloud 1504, generally referring to one or more networks in combination, as described herein, can communicate with the on-demand database service environment 1500 via one or more edge routers 1508 and 1512. A client machine can be any of the examples of user systems 12 described above. The edge routers can communicate with one or more core switches 1520 and 1524 through a firewall 1516. The core switches can communicate with a load balancer 1528, which can distribute server load over different pods, such as the pods 1540 and 1544. The pods 1540 and 1544, which can each include one or more servers or other computing resources, can perform data processing and other operations used to provide on-demand services. Communication with the pods can be conducted via pod switches 1532 and 1536. Components of the on-demand database service environment can communicate with database storage 1556 through a database firewall 1548 and a database switch 1552.

As shown in FIGS. 15A and 15B, accessing an on-demand database service environment can involve communications transmitted among a variety of different hardware or software components. Further, the on-demand database service environment 1500 is a simplified representation of an actual on-demand database service environment. For example, while only one or two devices of each type are shown in FIGS. 15A and 15B, some implementations of an on-demand database service environment can include anywhere from one to several devices of each type. Also, the on-demand database service environment need not include each device shown in FIGS. 15A and 15B, or can include additional devices not shown in FIGS. 15A and 15B.

Additionally, it should be appreciated that one or more of the devices in the on-demand database service environment 1500 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 1504 is intended to refer to a data network or multiple data networks, often including the Internet. Client machines communicably connected with the cloud 1504 can communicate with other components of the on-demand database service environment 1500 to access services provided by the on-demand database service environment. For example, client machines can access the on-demand database service environment to retrieve, store, edit, or process information. In some implementations, the edge routers 1508 and 1512 route packets between the cloud 1504 and other components of the on-demand database service environment 1500. For example, the edge routers 1508 and 1512 can employ the Border Gateway Protocol (BGP). The BGP is the core routing protocol of the Internet. The edge routers 1508 and 1512 can maintain a table of IP networks or ‘prefixes’, which designate network reachability among autonomous systems on the Internet.

In some implementations, the firewall 1516 can protect the inner components of the on-demand database service environment 1500 from Internet traffic. The firewall 1516 can block, permit, or deny access to the inner components of the on-demand database service environment 1500 based upon a set of rules and other criteria. The firewall 1516 can act as one or more of a packet filter, an application gateway, a stateful filter, a proxy server, or any other type of firewall.

In some implementations, the core switches 1520 and 1524 are high-capacity switches that transfer packets within the on-demand database service environment 1500. The core switches 1520 and 1524 can be configured as network bridges that quickly route data between different components within the on-demand database service environment. In some implementations, the use of two or more core switches 1520 and 1524 can provide redundancy or reduced latency.

In some implementations, the pods 1540 and 1544 perform the core data processing and service functions provided by the on-demand database service environment. Each pod can include various types of hardware or software computing resources. An example of the pod architecture is discussed in greater detail with reference to FIG. 15B. In some implementations, communication between the pods 1540 and 1544 is conducted via the pod switches 1532 and 1536. The pod switches 1532 and 1536 can facilitate communication between the pods 1540 and 1544 and client machines communicably connected with the cloud 1504, for example via core switches 1520 and 1524. Also, the pod switches 1532 and 1536 may facilitate communication between the pods 1540 and 1544 and the database storage 1556. In some implementations, the load balancer 1528 can distribute workload between the pods 1540 and 1544. Balancing the on-demand service requests between the pods can assist in improving the use of resources, increasing throughput, reducing response times, or reducing overhead. The load balancer 1528 may include multilayer switches to analyze and forward traffic.

In some implementations, access to the database storage 1556 is guarded by a database firewall 1548. The database firewall 1548 can act as a computer application firewall operating at the database application layer of a protocol stack. The database firewall 1548 can protect the database storage 1556 from application attacks such as structure query language (SQL) injection, database rootkits, and unauthorized information disclosure. In some implementations, the database firewall 1548 includes a host using one or more forms of reverse proxy services to proxy traffic before passing it to a gateway router. The database firewall 1548 can inspect the contents of database traffic and block certain content or database requests. The database firewall 1548 can work on the SQL application level atop the TCP/IP stack, managing applications' connection to the database or SQL management interfaces as well as intercepting and enforcing packets traveling to or from a database network or application interface.

In some implementations, communication with the database storage 1556 is conducted via the database switch 1552. The multi-tenant database storage 1556 can include more than one hardware or software components for handling database queries. Accordingly, the database switch 1552 can direct database queries transmitted by other components of the on-demand database service environment (for example, the pods 1540 and 1544) to the correct components within the database storage 1556. In some implementations, the database storage 1556 is an on-demand database system shared by many different organizations as described above with reference to FIG. 13 and FIG. 14.

15 FIG. 15B shows a system diagram further illustrating example architectural components of an on-demand database service environment according to some implementations. The pod 1544 can be used to render services to a user of the on-demand database service environment 1500. In some implementations, each pod includes a variety of servers or other systems. The pod 1544 includes one or more content batch servers 1564, content search servers 1568, query servers 1582, file force servers 1586, access control system (ACS) servers 1580, batch servers 1584, and app servers 1588. The pod 1544 also can include database instances 1590, quick file systems (QFS) 1592, and indexers 1594. In some implementations, some or all communication between the servers in the pod 1544 can be transmitted via the switch 1536.

In some implementations, the app servers 1588 include a hardware or software framework dedicated to the execution of procedures (for example, programs, routines, scripts) for supporting the construction of applications provided by the on-demand database service environment 1500 via the pod 1544. In some implementations, the hardware or software framework of an app server 1588 is configured to execute operations of the services described herein, including performance of the blocks of various methods or processes described herein. In some alternative implementations, two or more app servers 1588 can be included and cooperate to perform such methods, or one or more other servers described herein can be configured to perform the disclosed methods.

The content batch servers 1564 can handle requests internal to the pod. Some such requests can be long-running or not tied to a particular customer. For example, the content batch servers 1564 can handle requests related to log mining, cleanup work, and maintenance tasks. The content search servers 1568 can provide query and indexer functions. For example, the functions provided by the content search servers 1568 can allow users to search through content stored in the on-demand database service environment. The file force servers 1586 can manage requests for information stored in the File force storage 1598. The File force storage 1598 can store information such as documents, images, and basic large objects (BLOBs). By managing requests for information using the file force servers 1586, the image footprint on the database can be reduced. The query servers 1582 can be used to retrieve information from one or more file storage systems. For example, the query system 1582 can receive requests for information from the app servers 1588 and transmit information queries to the NFS 1596 located outside the pod.

The pod 1544 can share a database instance 1590 configured as a multi-tenant environment in which different organizations share access to the same database. Additionally, services rendered by the pod 1544 may call upon various hardware or software resources. In some implementations, the ACS servers 1580 control access to data, hardware resources, or software resources. In some implementations, the batch servers 1584 process batch jobs, which are used to run tasks at specified times. For example, the batch servers 1584 can transmit instructions to other servers, such as the app servers 1588, to trigger the batch jobs.

In some implementations, the QFS 1592 is an open source file storage system available from Sun Microsystems® of Santa Clara, Calif. The QFS can serve as a rapid-access file storage system for storing and accessing information available within the pod 1544. The QFS 1592 can support some volume management capabilities, allowing many disks to be grouped together into a file storage system. File storage system metadata can be kept on a separate set of disks, which can be useful for streaming applications where long disk seeks cannot be tolerated. Thus, the QFS system can communicate with one or more content search servers 1568 or indexers 1594 to identify, retrieve, move, or update data stored in the network file storage systems 1596 or other storage systems.

In some implementations, one or more query servers 1582 communicate with the NFS 1596 to retrieve or update information stored outside of the pod 1544. The NFS 1596 can allow servers located in the pod 1544 to access information to access files over a network in a manner similar to how local storage is accessed. In some implementations, queries from the query servers 1582 are transmitted to the NFS 1596 via the load balancer 1528, which can distribute resource requests over various resources available in the on-demand database service environment. The NFS 1596 also can communicate with the QFS 1592 to update the information stored on the NFS 1596 or to provide information to the QFS 1592 for use by servers located within the pod 1544.

In some implementations, the pod includes one or more database instances 1590. The database instance 1590 can transmit information to the QFS 1592. When information is transmitted to the QFS, it can be available for use by servers within the pod 1544 without using an additional database call. In some implementations, database information is transmitted to the indexer 1594. Indexer 1594 can provide an index of information available in the database 1590 or QFS 1592. The index information can be provided to file force servers 1586 or the QFS 1592.

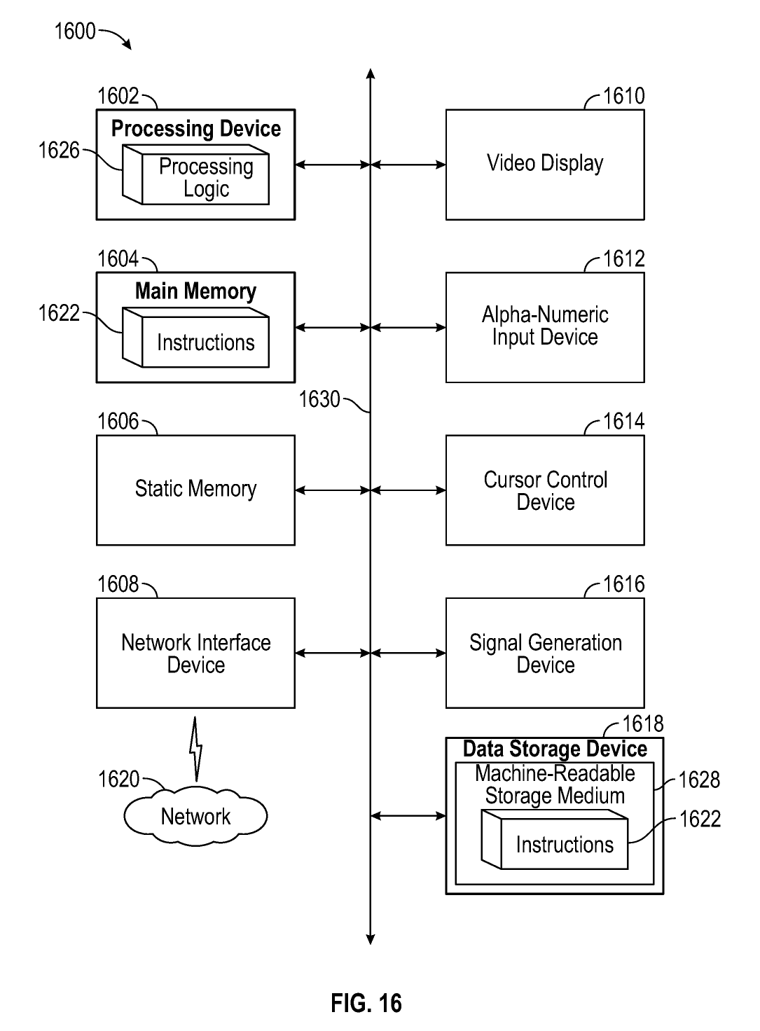

FIG. 16 illustrates a diagrammatic representation of a machine in the exemplary form of a computer system 1600 within which a set of instructions, for causing the machine to perform any one or more of the methodologies discussed herein, may be executed. The system 1600 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1600 may represent application server 110, as shown in FIGS. 2-4 and 6.

The exemplary computer system 1600 includes a processing device (processor) 1602, a main memory 1604 (e.g., read-only memory (ROM), flash memory, dynamic random access memory (DRAM) such as synchronous DRAM (SDRAM)), a static memory 1606 (e.g., flash memory, static random access memory (SRAM)), and a data storage device 1618, which communicate with each other via a bus 1630.

Processing device 1602 represents one or more general-purpose processing devices such as a microprocessor, central processing unit, or the like. More particularly, the processing device 1602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also be one or more special-purpose processing devices such as an application specific integrated circuit (ASIC), a field programmable gate array (FPGA), a digital signal processor (DSP), network processor, or the like.

The computer system 1600 may further include a network interface device 1608. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), and a signal generation device 1616 (e.g., a speaker).

The data storage device 1618 may include a computer-readable medium 1628 on which is stored one or more sets of instructions 1622 (e.g., instructions of in-memory buffer service 114) embodying any one or more of the methodologies or functions described herein. The instructions 1622 may also reside, completely or at least partially, within the main memory 1604 and/or within processing logic 1626 of the processing device 1602 during execution thereof by the computer system 1600, the main memory 1604 and the processing device 1602 also constituting computer-readable media. The instructions may further be transmitted or received over a network 1620 via the network interface device 1608.

While the computer-readable storage medium 1628 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for displaying a context-sensitive overlay in conjunction with a calendar displayed by a calendar application, the method comprising:
determining, at the calendar application, contextual information from the calendar that indicates context for the calendar, wherein the contextual information comprises: calendar data or third-party data linked to calendar items that are displayed in the calendar;
automatically querying a backend system to dynamically determine, at the calendar application based on the contextual information, at least one context-sensitive overlay that is pertinent to the calendar in view of the contextual information and provides supplemental information that is directly associated with the contextual information from the calendar; and
displaying the calendar with the context-sensitive overlay superimposed on at least a portion of the calendar.

2. The method according to claim 1, further comprising:
generating a list of pertinent context-sensitive overlays that are determined to be pertinent to the calendar and available to be displayed in conjunction with the calendar; and
displaying the list of pertinent context-sensitive overlays at a user interface with options for selecting one or more of the context-sensitive overlays to be displayed.

3. The method according to claim 1, wherein the step of automatically querying, comprises:
analyzing each stored associative rule to determine whether any of the contextual information matches a pattern defined by associative data for that associative rule;
identifying a set of stored associative rules that are applicable to the calendar, the set of stored associative rules comprising: each of the stored associative rules that was determined to have a pattern that matches the contextual information, wherein each of the stored associate rules has a corresponding context-sensitive overlay; and
generating a set of stored context-sensitive overlays based on the set of stored associative rules that are determined to be applicable to the calendar.

4. The method according to claim 3, wherein the step of automatically querying, further comprises:
processing, via an association rule-learning algorithm, the contextual information to extract one or more patterns from the contextual information;
generating, based on each new pattern that was extracted, a new associative rule comprising associative data that reflects that new pattern, wherein each new associative rule corresponds to a new context-sensitive overlay; and
generating, based on the new associative rules, new context-sensitive overlays that are applicable for the calendar.

5. The method according to claim 4, further comprising:
adding the set of stored context-sensitive overlays and the new context-sensitive overlays to the list of pertinent context-sensitive overlays;
receiving input from a user system that indicates selection of at least one of the pertinent context-sensitive overlays from the list of pertinent context-sensitive overlays; and
displaying the selected, pertinent context-sensitive overlays each being superimposed on at least a portion of the calendar.

6. The method according to claim 1, wherein the calendar application persists the association between the selected, pertinent context-sensitive overlay and the calendar such that the selected, pertinent context-sensitive overlay is: displayed when the calendar is displayed, hidden when the calendar is hidden, and shared when the calendar is shared.

7. The method according to claim 1, wherein the calendar data comprises:
data defined on the calendar.

8. The method according to claim 1, wherein the calendar data comprises:
data defined on items that are displayed in the calendar.

9. The method according to claim 8, wherein the items are one or more of: calendar events and calendarable records being displayed on the calendar.

10. A computing system comprising a processor and a memory, wherein the memory comprises computer-executable instructions that are configurable to cause the computing system to:
determine contextual information from a calendar that indicates context for the calendar, wherein the contextual information comprises: calendar data or third-party data linked to calendar items that are displayed in the calendar;
automatically query a backend system to dynamically determine, based on the contextual information, at least one context-sensitive overlay that is pertinent to the calendar in view of the contextual information and provides supplemental information that is directly associated with the contextual information from the calendar; and
displaying the calendar with the context-sensitive overlay superimposed on at least a portion of the calendar.

11. The computing system of claim 10, wherein the computer-executable instructions are further configurable to cause the computing system to:
generate a list of pertinent context-sensitive overlays that are determined to be pertinent to the calendar and available to be displayed in conjunction with the calendar; and
display the list at a user interface with options for selecting one or more of the context-sensitive overlays to be displayed.

12. The computing system of claim 11, wherein the computer-executable instructions are further configurable to cause the computing system to automatically query the backend systems to:
analyze each stored associative rule to determine whether any of the contextual information matches a pattern defined by associative data for that associative rule;
identify a set of stored associative rules that are applicable to the calendar, the set of stored associative rules comprising: each of the stored associative rules that was determined to have a pattern that matches the contextual information, wherein each of the stored associate rules has a corresponding context-sensitive overlay; and
generate a set of stored context-sensitive overlays based on the set of stored associative rules that are determined to be applicable to the calendar.

13. The computing system of claim 12, wherein the computer-executable instructions are further configurable to cause the computing system to automatically query the backend systems to:
process, via an association rule-learning algorithm, the contextual information to extract one or more patterns from the contextual information;
generate, based on each new pattern that was extracted, a new associative rule comprising associative data that reflects that new pattern, wherein each new associative rule corresponds to a new context-sensitive overlay; and
generate, based on the new associative rules, new context-sensitive overlays that are applicable for the calendar.

14. The computing system of claim 13, wherein the computer-executable instructions are further configurable to cause the computing system to:
add the set of stored context-sensitive overlays and the new context-sensitive overlays to the list of pertinent context-sensitive overlays;
receive input from a user system that indicates selection of at least one of the pertinent context-sensitive overlays from the list of pertinent context-sensitive overlays; and
display the selected, pertinent context-sensitive overlays each being superimposed on at least a portion of the calendar.

15. The computing system of claim 10, wherein the association between the selected, pertinent context-sensitive overlay and the calendar is persisted such that the selected, pertinent context-sensitive overlay is: displayed when the calendar is displayed, hidden when the calendar is hidden, and shared when the calendar is shared.

16. The computing system of claim 10, wherein the calendar data comprises one or more of:
data defined on the calendar; and
data defined on items that are displayed in the calendar, wherein the items are one or more of: calendar events and calendarable records being displayed on the calendar.

17. A calendar system for or displaying a context-sensitive overlay in conjunction with a calendar displayed by a calendar application, the calendar system comprising:
a cloud computing platform configured to provide a calendar application to the user system;
one or more backend systems;
a user system comprising a user interface that displays a calendar generated by the calendar application, wherein the calendar application is configurable to:
determine contextual information from the calendar that indicates context for the calendar, wherein the contextual information comprises: calendar data or third-party data linked to calendar items that are displayed in the calendar;
automatically query the backend systems to dynamically determine, based on the contextual information, at least one context-sensitive overlay that is pertinent to the calendar in view of the contextual information and provides supplemental information that is directly associated with the contextual information from the calendar;
generate the at least one context-sensitive overlay; and
display the context-sensitive overlay superimposed on at least a portion of the calendar at the user interface of the user system.

18. The calendar system of claim 17, wherein the calendar application is further configurable to:
generate a list of pertinent context-sensitive overlays that are determined to be pertinent to the calendar and available to be displayed in conjunction with the calendar; and
display the list of pertinent context-sensitive overlays at a user interface with options for selecting one or more of the context-sensitive overlays to be displayed.

19. The calendar system of claim 18, wherein the calendar application is further configurable to automatically query the backend systems to:
analyze each stored associative rule to determine whether any of the contextual information matches a pattern defined by associative data for that associative rule;
identify a set of stored associative rules that are applicable to the calendar, the set of stored associative rules comprising: each of the stored associative rules that was determined to have a pattern that matches the contextual information, wherein each of the stored associate rules has a corresponding context-sensitive overlay; and
generate a set of stored context-sensitive overlays based on the set of stored associative rules that are determined to be applicable to the calendar.

20. The calendar system of claim 19, wherein the calendar application is further configurable to automatically query the backend systems to:
process the contextual information, via an association rule-learning algorithm, to extract one or more patterns from the contextual information;
generate, based on each new pattern that was extracted, a new associative rule comprising associative data that reflects that new pattern, wherein each new associative rule corresponds to a new context-sensitive overlay; and
generate, based on the new associative rules, new context-sensitive overlays that are applicable for the calendar.
